(19) United States
(12) Patent Application Publication
(10) Pub. No.: US 2025/0353407 A1
(43) Pub. Date: Nov. 20, 2025

(54) SLIDE LOCK DEVICE AND ASSEMBLY METHOD FOR SLIDE DEVICE

(71) Applicants: TS TECH CO., LTD., Asaka-shi, Saitama (JP); IMASEN ELECTRIC INDUSTRIAL CO., LTD., Inuyama-shi, Aichi (JP)

(72) Inventors: Takeshi AKUTSU, Shioya-gun, Tochigi (JP); Tatsuo SAYAMA, Shioya-gun, Tochigi (JP); Ryosuke TAKEDA, Shioya-gun, Tochigi (JP); Yoichi TACHIKAWA, Shioya-gun, Tochigi (JP); Fumitaka INOUE, Inuyama-shi, Aichi (JP); Tatsunori KOSUGE

(21) Appl. No.: 18/704,668

(22) PCT Filed: Oct. 25, 2022
(86) PCT No.: PCT/JP2022/039744

§ 371 Date: Oct. 16, 2024

Related U.S. Application Data
(60) Provisional application No. 63/263,038, filed on Oct. 26, 2021.
(60) Provisional application No. 63/274,238, filed on Nov. 1, 2021.
(60) Provisional application No. 63/263,826, filed on Nov. 10, 2021.
(60) Provisional application No. 63/293,896, filed on Dec. 27, 2021.
(60) Provisional application No. 63/321,250, filed on Mar. 18, 2022.
(60) Provisional application No. 63/366,653, filed on Jun. 20, 2022.

(51) Int. Cl. B60N 2/08

(52) U.S. Cl. CPC B60N 2/08

(57) ABSTRACT

A slide device includes a rail and a slider. The rail is provided with multiple locking holes arranged in an extension direction of the rail. The slide lock device includes a casing joined to the slider, at least one lock member supported by the casing to be rotatable between a release position and a lock position, an urging member urging the lock member toward the lock position, and an operating member displaceably supported by the casing and contacting the lock member. The lock member includes at least one convex part configured to be engaged with the locking holes when the lock member is in the lock position and to be disengaged from the locking holes when the lock member is in the release position. When the operating member is moved from an initial position to a post-operation position, the operating member presses the lock member and moves the lock member from the lock position to the release position.

### TECHNICAL FIELD

The present invention relates to a slide lock device and an assembly method for a slide device.

### BACKGROUND ART

A slide device for supporting a seat for an automobile on a floor to be slidingly movable is known. Patent Document 1 discloses a slide lock device including a rail, a slider slidably supported on the rail, and a lock device for fixing the position of the slider relative to the rail. The slide lock device includes a casing joined to the slider, a pair of lock members supported by the casing to be displaceable between a release position and a lock position, an urging member that urges the lock members toward the lock position, and an operating member displaceably supported by the casing and contacting the lock members. The operating member is driven by a lever operated by a user and moves the lock members from the lock position to the release position.

### PRIOR ART DOCUMENT(S)

### Patent Document

Patent Document 1: WO2021/125343A1

### SUMMARY OF THE INVENTION

### Task to be Accomplished by the Invention

In the slide lock device of Patent Document 1, the operating member is supported by the casing to be displaceable in the up-down direction, and the lock members are supported to be displaceable in the left-right direction. The movement of the operating member in the up-down direction is converted by a cam to the movement of the lock member in the left-right direction. Therefore, there may be a case where the lock member receiving a load in the up-down direction is pressed against the casing so that the lock member cannot move smoothly in the left-right direction.

In view of the foregoing background, an object of the present invention is to provide a slide lock device that can operate smoothly. Also, the present invention aims to provide an assembly method for a slide device that can operate smoothly.

### Means to Accomplish the Task

To achieve the above object, one aspect of the present invention is a slide lock device (30) for a slide device (1), wherein the slide device comprises a rail (11) and a slider (12) slidably supported on the rail, the rail being provided with multiple locking holes (15) arranged in an extension direction of the rail, the slide lock device comprises a casing (31) joined to the slider, at least one lock member (32) supported by the casing to be rotatable between a release position and a lock position, an urging member (33) urging the lock member toward the lock position, and an operating member (34) displaceably supported by the casing and contacting the lock member, the lock member comprises at least one convex part (32B) configured to be engaged with the locking holes when the lock member is in the lock position and to be disengaged from the locking holes when the lock member is in the release position, and when the operating member is moved from an initial position to a post-operation position the operating member presses the lock member and moves the lock member from the lock position to the release position.

According to this aspect, since the lock member is rotatably supported by the casing, the lock member can smoothly move from the lock position to the release position when the lock member is pushed by the operating member. Thus, it is possible to provide a slide lock device that can operate smoothly.

In the above aspect, the operating member may be supported by the casing to be pivotable between the initial position and the post-operation position.

According to this aspect, since the operating member is rotatably supported by the casing, the operating member can be smoothly moved from the initial position to the post-operation position.

In the above aspect, the convex part may extend helically about a rotation axis of the lock member, and the casing may be provided with a helical groove (31C) for slidably receiving the convex part.

According to this aspect, with the convex part sliding in the helical groove, the lock member can smoothly rotate from the lock position to the release position.

In the above aspect, the convex part may protrude from the casing when the lock member is in the lock position, and the convex part may be positioned within the casing when the lock member is in the release position.

According to this aspect, a gap between the casing and the rail can be made small.

In the above aspect, the lock member may include an arm part (32C) protruding in a direction perpendicular to the rotation axis of the lock member, the operating member may press the arm part in a first direction parallel to a tangential direction about the rotation axis of the lock member, and the arm part and the operating member may have no overlap in the first direction when the lock member reaches the release position.

According to this aspect, even when an excessive load is applied to the operating member, the load is not transmitted to the arm part. Therefore, fracture of the lock member is prevented.

In the above aspect, a pair of the lock members may be disposed in parallel with each other, a pair of the arm parts may extend in directions toward each other when each of the lock members is in the lock position, and the operating member may contact each of the pair of the arm parts.

According to this aspect, since a pair of lock members is provided, the lock members can be engaged with the rail with good stability.

In the above aspect, the slider may include an upper wall and a pair of side walls extending downward from the upper wall, the casing may be joined to a bottom surface of the upper wall and is disposed between the pair of side walls, and parts of the pair of side walls opposing the casing may be formed with an opening (12F) through which the convex part can pass.

According to this aspect, the slide lock device can be disposed inside the slider in a space-efficient manner.

In the above aspect, the operating member may protrude above the upper wall by passing through an operation hole (36) formed in the upper wall.

According to this aspect, the slide lock device can be disposed inside the slider in a space-efficient manner.

Another aspect of the present invention is an assembly method for a slide device (1), wherein the slide device comprises a rail (11), a slider (12) slidably supported on the rail, and a slide lock device (30) provided on the slider and configured to be engaged with the rail, the rail being provided with multiple locking holes (15) arranged in an extension direction of the rail, the slide lock device comprises a casing (31) joined to the slider, at least one lock member (32) supported by the casing to be rotatable between a release position and a lock position, an urging member (33) urging the lock member toward the lock position, and an operating member (34) displaceably supported by the casing and contacting the lock member, and the lock member comprises at least one convex part (32B) configured to be engaged with the locking holes when the lock member is in the lock position and to be disengaged from the locking holes when the lock member is in the release position, the assembly method comprising: a step of assembling the slide lock device by mounting the lock member, the urging member, and the operating member to the casing: a step of mounting the casing to the slider; and a step of mounting the slider to the rail.

According to this aspect, it is possible to assemble the slide lock device to the inner side of the slider in a work-efficient manner.

In the above aspect, the casing may include multiple casing members (31A, 31B), and the step of assembling the slide lock device may comprise: a step of mounting the urging member to the lock member: a step of making one of the multiple casing members support the lock member to which the urging member is mounted and the operating member; and a step of joining the multiple casing members to each other.

According to this aspect, it is possible to assemble the slide lock device in a work-efficient manner.

### Effect of the Invention

One aspect of the present invention is a slide lock device (30) for a slide device (1), wherein the slide device comprises a rail (11) and a slider (12) slidably supported on the rail, the rail being provided with multiple locking holes (15) arranged in an extension direction of the rail, the slide lock device comprises a casing (31) joined to the slider, at least one lock member (32) supported by the casing to be rotatable between a release position and a lock position, an urging member (33) urging the lock member toward the lock position, and an operating member (34) displaceably supported by the casing and contacting the lock member, the lock member comprises at least one convex part (32B) configured to be engaged with the locking holes when the lock member is in the lock position and to be disengaged from the locking holes when the lock member is in the release position, and when the operating member is moved from an initial position to a post-operation position the operating member presses the lock member and moves the lock member from the lock position to the release position.

According to this aspect, since the lock member is rotatably supported by the casing, the lock member can smoothly move from the lock position to the release position when the lock member is pushed by the operating member. Thus, it is possible to provide a slide lock device that can operate smoothly.

In the above aspect, the operating member may be supported by the casing to be pivotable between the initial position and the post-operation position.

According to this aspect, since the operating member is rotatably supported by the casing, the operating member can be smoothly moved from the initial position to the post-operation position.

In the above aspect, the convex part may extend helically about a rotation axis of the lock member, and the casing may be provided with a helical groove (31C) for slidably receiving the convex part.

According to this aspect, with the convex part sliding in the helical groove, the lock member can smoothly rotate from the lock position to the release position.

In the above aspect, the convex part may protrude from the casing when the lock member is in the lock position, and the convex part may be positioned within the casing when the lock member is in the release position.

According to this aspect, a gap between the casing and the rail can be made small.

In the above aspect, the lock member may include an arm part (32C) protruding in a direction perpendicular to the rotation axis of the lock member, the operating member may press the arm part in a first direction parallel to a tangential direction about the rotation axis of the lock member, and the arm part and the operating member may have no overlap in the first direction when the lock member reaches the release position.

According to this aspect, even when an excessive load is applied to the operating member, the load is not transmitted to the arm part. Therefore, fracture of the lock member is prevented.

In the above aspect, a pair of the lock members may be disposed in parallel with each other, a pair of the arm parts may extend in directions toward each other when each of the lock members is in the lock position, and the operating member may contact each of the pair of the arm parts.

According to this aspect, since a pair of lock members is provided, the lock members can be engaged with the rail with good stability.

In the above aspect, the slider may include an upper wall and a pair of side walls extending downward from the upper wall, the casing may be joined to a bottom surface of the upper wall and is disposed between the pair of side walls, and parts of the pair of side walls opposing the casing may be formed with an opening (12F) through which the convex part can pass.

According to this aspect, the slide lock device can be disposed inside the slider in a space-efficient manner.

In the above aspect, the operating member may protrude above the upper wall by passing through an operation hole (36) formed in the upper wall.

According to this aspect, the slide lock device can be disposed inside the slider in a space-efficient manner.

Another aspect of the present invention is an assembly method for a slide device (1), wherein the slide device comprises a rail (11), a slider (12) slidably supported on the rail, and a slide lock device (30) provided on the slider and configured to be engaged with the rail, the rail being provided with multiple locking holes (15) arranged in an extension direction of the rail, the slide lock device comprises a casing (31) joined to the slider, at least one lock member (32) supported by the casing to be rotatable between a release position and a lock position, an urging member (33) urging the lock member toward the lock position, and an operating member (34) displaceably supported by the casing and contacting the lock member, and the lock member comprises at least one convex part (32B) configured to be engaged with the locking holes when the lock member is in the lock position and to be disengaged from the locking holes when the lock member is in the release position, the assembly method comprising: a step of assembling the slide lock device by mounting the lock member, the urging member, and the operating member to the casing: a step of mounting the casing to the slider; and a step of mounting the slider to the rail.

According to this aspect, it is possible to assemble the slide lock device to the inner side of the slider in a work-efficient manner.

In the above aspect, the casing may include multiple casing members (31A, 31B), and the step of assembling the slide lock device may comprise: a step of mounting the urging member to the lock member; a step of making one of the multiple casing members support the lock member to which the urging member is mounted and the operating member; and a step of joining the multiple casing members to each other.

According to this aspect, it is possible to assemble the slide lock device in a work-efficient manner.

### BRIEF DESCRIPTION OF THE DRAWINGS

FIG. 1 is a configuration diagram of a vehicle seat;

FIG. 2 is a perspective view of an electric slide rail according to the first embodiment;

FIG. 3 is a sectional view of the electric slide rail according to the first embodiment;

FIG. 4 is a sectional view of the rail;

FIG. 5 is a perspective view of a slide lock device according to the first embodiment;

FIG. 6 is an exploded perspective view of the slide lock device according to the first embodiment;

FIG. 7 is a perspective view showing an inner surface (lower surface) of an upper casing member;

FIG. 8 is a perspective view of the slide lock device, with the upper casing member being omitted;

FIG. 9 is a sectional view of a slide device according to the first embodiment in a locked state;

FIG. 10 is a sectional view of the slide device according to the first embodiment in a release state;

FIG. 11 is a perspective view of a slide lock device according to the second embodiment;

FIG. 12 is a perspective view of the slide lock device according to the second embodiment (with an upper casing being omitted);

FIG. 13 is an exploded perspective view of the slide lock device according to the second embodiment;

FIG. 14 is a perspective view of a lock member of the slide lock device according to the second embodiment;

FIG. 15 is a sectional view of the slide lock device according to the second embodiment;

FIG. 16 is an explanatory diagram showing a slide lock device according to the third embodiment as seen from above, in which (A) shows a locked state and (B) shows a release state:

FIG. 17 is an explanatory diagram showing the slide lock device according to the third embodiment in the locked state as seen from the front:

FIG. 18 is an explanatory diagram showing the slide lock device according to the third embodiment in the release state as seen from the front:

FIG. 19 is an explanatory diagram showing a slide lock device according to the fourth embodiment as seen from the front, in which (A) shows a locked state and (B) shows a release state:

FIG. 20 is an explanatory diagram of the slide lock device according to the fifth embodiment as seen from above, in which (A) shows a locked state and (B) shows a release state:

FIG. 21 is an explanatory diagram showing the slide lock device according to the sixth embodiment in the release state as seen from the front:

FIG. 22 is an explanatory diagram showing a slide lock device according to the seventh embodiment as seen from above:

FIG. 23 is the locked state an explanatory diagram showing a slide lock device according to the eighth embodiment as seen from the front:

FIG. 24 is the locked state an explanatory diagram showing a slide lock device according to the ninth embodiment as seen from the front:

FIG. 25 is the locked state an explanatory diagram of a slide lock device according to the tenth embodiment as seen from the front:

FIG. 26 is an exploded perspective view of a slide lock device according to the eleventh embodiment:

FIG. 27 is a perspective view showing the slide lock device according to the eleventh embodiment as seen from below:

FIG. 28 is an exploded perspective view of a slide lock device according to the twelfth embodiment:

FIG. 29 is an explanatory diagram showing the slide lock device according to the twelfth embodiment in the locked state as seen from the front;

FIG. 30 is an explanatory diagram showing the slide lock device according to the twelfth embodiment in the release state as seen from the front:

FIG. 31 is an exploded perspective view of a slide lock device according to the thirteenth embodiment:

FIG. 32 is an explanatory diagram showing the slide lock device according to the thirteenth embodiment in the locked state as seen from the front;

FIG. 33 is an explanatory diagram showing the slide lock device according to the thirteenth embodiment in the release state as seen from the front:

FIG. 34 is an explanatory diagram showing a slide lock device according to the fourteenth embodiment in the locked state as seen from the front:

FIG. 35 is an explanatory diagram showing the slide lock device according to the fourteenth embodiment in the release state as seen from the front:

FIG. 36 is a perspective view of a slide lock device according to the fifteenth embodiment:

FIG. 37 is a perspective view of the slide lock device according to the fifteenth embodiment, with a casing being omitted;

FIG. 38 is a perspective view of an operating member of the slide lock device according to the fifteenth embodiment:

FIG. 39 is an explanatory diagram showing the slide lock device according to the fifteenth embodiment in the locked state as seen from the front:

FIG. 40 is an explanatory diagram showing the slide lock device according to the fifteenth embodiment in the release state as seen from the front;

FIG. 41 is a perspective view of an electric slide rail according to the sixteenth embodiment;

FIG. 42 is a perspective view of a screw assembly according to the sixteenth embodiment;

FIG. 43 is an exploded perspective view of the screw assembly according to the sixteenth embodiment;

FIG. 44 is a perspective view of a main part of a screw assembly according to the seventeenth embodiment;

FIG. 45 is a perspective view of the main part of the screw assembly according to the seventeenth embodiment;

FIG. 46 is an explanatory diagram of the screw assembly according to the seventeenth embodiment;

FIG. 47 is an explanatory diagram showing locking holes of the rail;

FIG. 48 is an explanatory diagram of one example of a slider of an electric slide rail as seen from the left;

FIG. 49 is an explanatory diagram showing the slider of the electric slide rail as seen from above;

FIG. 50 is an explanatory diagram of one example of a slider of an electric slide rail as seen from the left;

FIG. 51 is an explanatory diagram of one example of a slider of an electric slide rail as seen from the left;

FIG. 52 is an explanatory diagram of one example of a slider of an electric slide rail as seen from the left;

FIG. 53 is an explanatory diagram of one example of a slider of an electric slide rail as seen from above;

FIG. 54 is an explanatory diagram of one example of an electric slide rail as seen from above;

FIG. 55 is an explanatory diagram of one example of an electric slide rail as seen from above;

FIG. 56 is an explanatory diagram of one example of an electric slide rail as seen from above;

FIG. 57 is an explanatory diagram of one example of an electric slide rail as seen from above;

FIG. 58 is an explanatory diagram of one example of a vehicle as seen from above;

FIG. 59 is an explanatory diagram of one example of a vehicle as seen from above;

FIG. 60 is an explanatory diagram of one example of a vehicle seat provided with an electric slide rail as seen from the left;

FIG. 61 is an explanatory diagram of one example of a vehicle seat provided with an electric slide rail as seen from below;

FIG. 62 is an explanatory diagram of one example of a vehicle seat provided with an electric slide rail as seen from the left;

FIG. 63 is an explanatory diagram of one example of a vehicle seat provided with an electric slide rail as seen from the left; and

FIG. 64 is an explanatory diagram of one example of a vehicle seat provided with an electric slide rail as seen from the left.

### MODE(S) FOR CARRYING OUT THE INVENTION

In the following, embodiments of the present invention will be described with reference to the drawings. The slide device includes a rail and a slider slidably movable relative to the rail. The rail is joined to a first structural body, and the slider is joined to a second structural body. With the slider moving relative to the rail, the slide device causes the second structural body to move relative to the first structural body. For example, the slide device is provided between the floor of the vehicle and a seat to move the seat relative to the floor. Also, an electric slide rail is provided between a base and a work holder to move the work holder relative to the base.

### First Embodiment

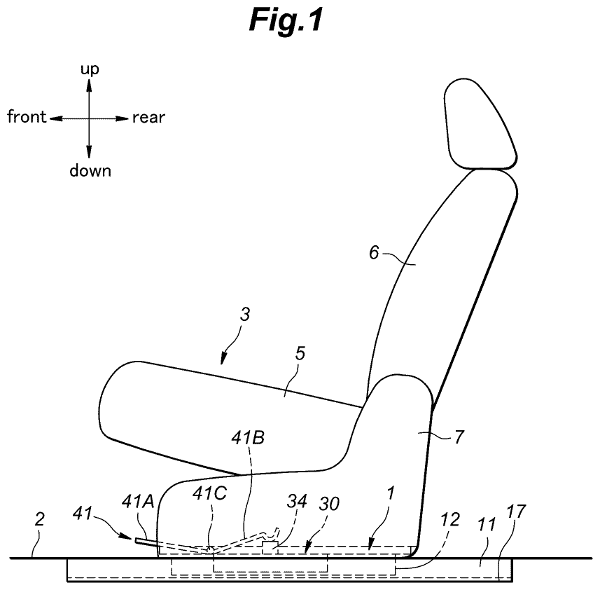

As shown in FIG. 1, a slide device 1 is provided between a floor 2 of a vehicle and a vehicle seat 3. The vehicle seat 3 includes a seat cushion 5 for supporting buttocks of an occupant and a seatback 6 extending upward from a rear portion of the seat cushion 5 to support the back of the occupant. The slide device 1 is provided between the floor 2 and the seat cushion 5 and supports the seat cushion 5 to be slidingly movable relative to the floor 2. On side portions of the seat cushion 5, a cover 7 for hiding the gap between the seat cushion 5 and the floor 2 is provided.

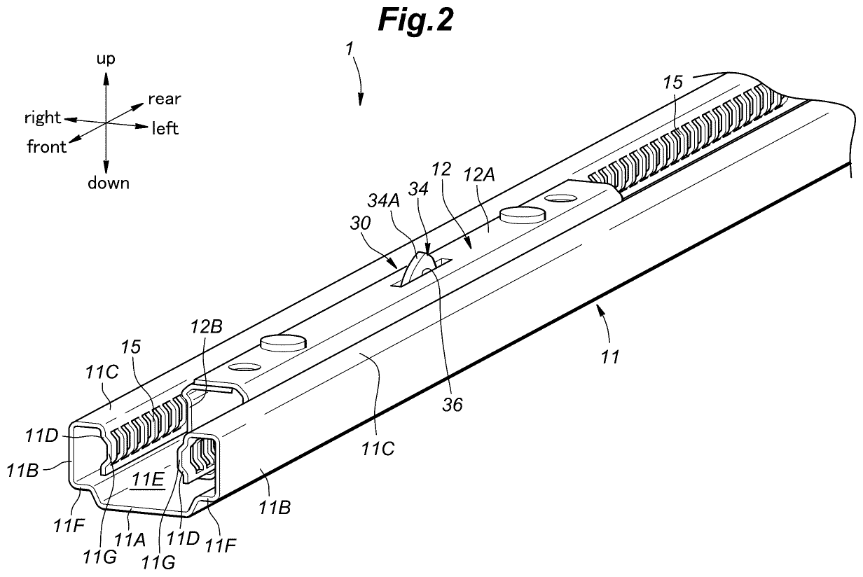

As shown in FIG. 2, the slide device 1 includes left and right rails 11 extending in the front-rear direction and left and right sliders 12 slidably supported on the respective rails 11. The extension direction of the rails 11 is defined as the front-rear direction. The extension direction of the rails 11 may or may not coincide with the front-rear direction of the vehicle. Namely, the extension direction of the rails 11 does not limit the installation direction in the vehicle. In the present embodiment, the extension direction of the rails 11 coincides with the front-rear direction of the vehicle. In the present embodiment, the slider 12 is provided on the upper side of the rail 11. Therefore, the rail 11 may be referred to as a lower rail, and the slider 12 may be referred to as an upper rail.

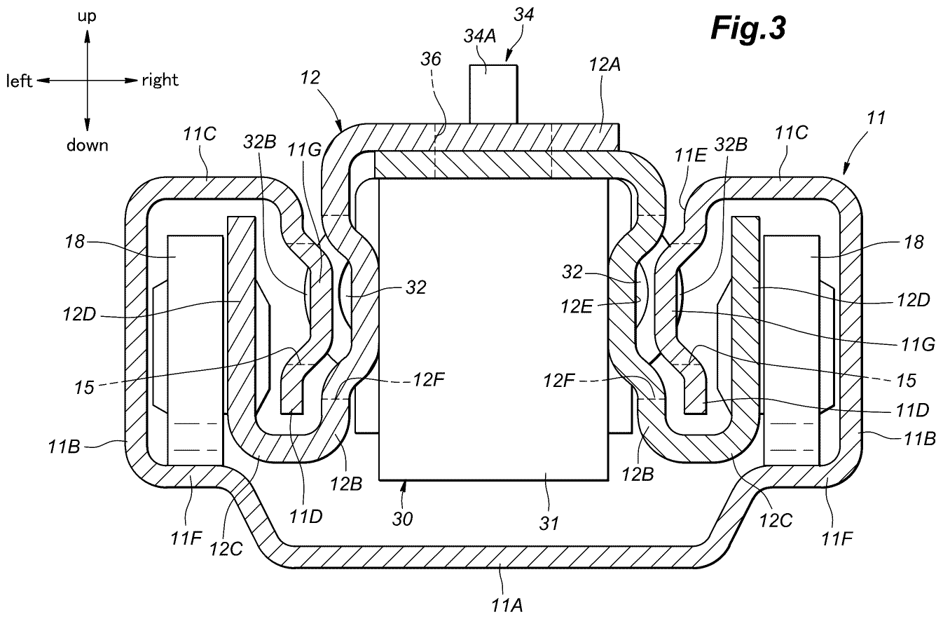

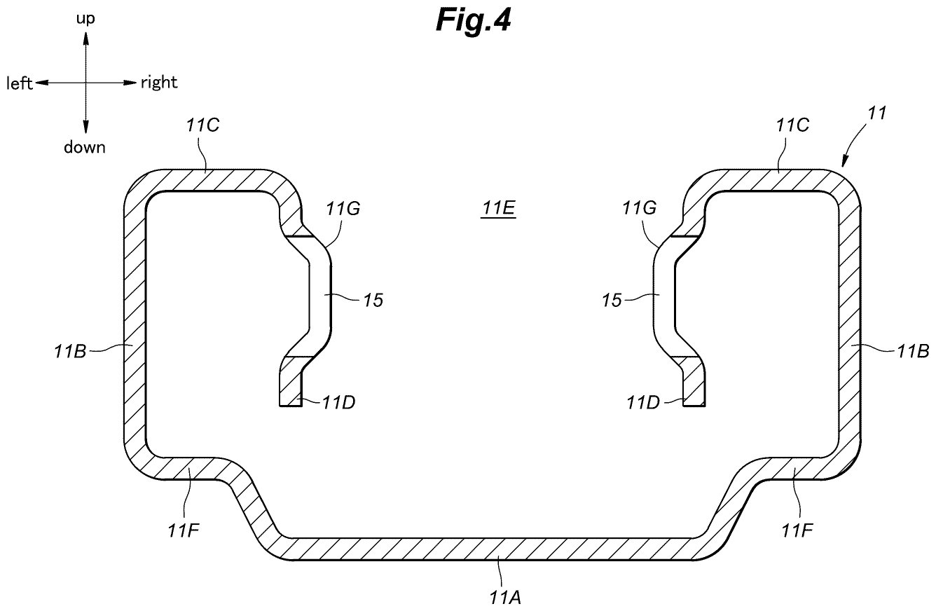

As shown in FIGS. 3 and 4, the rail 11 has a groove-shaped cross section. Specifically, the rail 11 includes a rail bottom wall 11A having surfaces facing upward and downward, left and right rail outer side walls 11B respectively extending upward from left and right edge parts of the rail bottom wall 11A and having surfaces facing leftward and rightward, left and right rail upper walls 11C respectively extending from upper ends of the left and right rail outer side walls 11B in directions toward each other and having surfaces facing upward and downward, and left and right rail inner side walls 11D respectively extending downward from inner ends of the left and right rail upper walls 11C and having surfaces facing leftward and rightward.

The rail bottom wall 11A, the left and right rail outer side walls 11B, the left and right rail upper walls 11C, and the left and right rail inner side walls 11D each extend in the front-rear direction. The left and right rail outer side walls 11B and the left and right rail inner side walls 11D extend in parallel with each other and perpendicularly to the rail bottom wall 11A. The lower ends of the left and right rail inner side walls 11D are disposed to be spaced from the rail bottom wall 11A. The rail 11 has, in an upper portion thereof, a rail opening 11E that extends in the front-rear direction. The rail opening 11E is defined by the left and right rail inner side walls 11D. The rail 11 is preferably formed by press-forming a metal sheet. Each of left and right edge portions of the rail bottom wall 11A may be provided with a stepped part 11F that is raised upward. The left and right stepped parts 11F extend in the front-rear direction and their upper surfaces are formed to be flat.

The left and right rail inner side walls 11D are formed with respective projections 11G that protrude in directions toward each other and extend in the front-rear direction. The cross section of each of the left and right projections 11G is preferably formed in an arc shape or a trapezoidal shape. Each projection 11G is preferably disposed in a vertically intermediate portion of the corresponding rail inner side wall 11D. The upper end portion and the lower end portion of each of the left and right rail inner side walls 11D are disposed laterally outward of the projection 11G.

As shown in FIGS. 2 to 4, the rail 11 is provided with multiple locking holes 15 arranged in the extension direction of the rails 11, namely, in the front-rear direction. The multiple locking holes 15 are formed in the projection 11G of the corresponding rail inner side wall 11D. The locking holes 15 extend in parallel with each other. Each locking hole 15 extends in the up-down direction. Preferably, each locking hole 15 is inclined forward or rearward.

The floor 2 is formed with left and right rail grooves 17 that are recessed downward. The rails 11 are preferably disposed in the corresponding rail grooves 17.

As shown in FIG. 3, the slider 12 includes a plate-shaped slider upper wall 12A disposed in the open end of the rail opening 11E and having surfaces facing upward and downward, left and right slider inner side walls 12B respectively extending toward the rail bottom wall 11A, namely, downward, from left and right side edges of the slider upper wall 12A, left and right slider lower walls 12C respectively extending laterally outward from lower ends of the left and right slider inner side walls 12B, and left and right slider outer side walls 12D respectively extending upward from laterally outer ends of the left and right slider lower walls 12C. The slider upper wall 12A, the left and right slider inner side walls 12B, the left and right slider lower walls 12C, and the left and right slider outer side walls 12D extend in the front-rear direction.

The slider 12 is preferably formed by fastening together multiple press-formed or roll-formed metal sheets. In another embodiment, the slider 12 may be formed of a single press-formed or roll-formed metal sheet. The front-rear length of the slider 12 is set to be shorter than the front-rear length of the rail 11. The slider 12 is joined to the seat cushion 5 at the slider upper wall 12A.

The slider upper wall 12A may be disposed higher than the left and right rail upper walls 11C or may be disposed lower than the left and right rail upper walls 11C. The left and right slider inner side walls 12B have surfaces facing leftward and rightward and oppose each other to be laterally spaced from each other. The left and right slider inner side walls 12B are disposed between the left and right rail inner side walls 11D. Each slider inner side wall 12B opposes the laterally corresponding rail inner side wall 11D via a gap. Each slider lower wall 12C passes between the rail bottom wall 11A and the lower end of the laterally corresponding rail inner side wall 11D and extends laterally. Each outer wall of the slider 12 is disposed between the rail outer side wall 11B and the rail inner side wall 11D laterally corresponding thereto. On the laterally outer surface side of each slider outer side wall 12D, multiple wheels 18 are rotatably supported. Each wheel 18 has a rotation axis extending in the left-right direction and is in contact with the rail bottom wall 11A. In the present embodiment, each wheel 18 is in contact with the upper surface of the stepped part 11F of the rail bottom wall 11A. By contacting the rail 11 via the wheels 18, the slider 12 can smoothly slide relative to the rail 11. With the foregoing configuration, the slider 12 is received in the rail 11 and is slidably engaged with the rail 11. In another embodiment, the slider 12 may be supported on the rail 11 via balls or a roller bearing.

The left and right slider inner side walls 12B are formed with recessed parts 12E that are recessed in directions toward each other and extend in the front-rear direction. A projection is formed on the back side of the recessed part 12E of each slider inner side wall 12B. The cross section of each of the left and right recessed parts 12E as seen in the front-rear direction is preferably formed in an arc shape or a trapezoidal shape. Each recessed part 12E is preferably disposed in a vertically intermediate portion of the corresponding slider inner side wall 12B. Each recessed part 12E is disposed in a position opposing the projection 11G of the laterally corresponding rail 11.

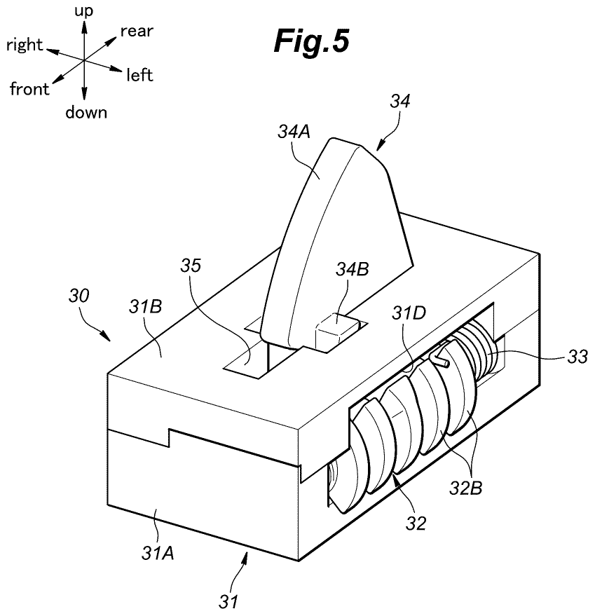

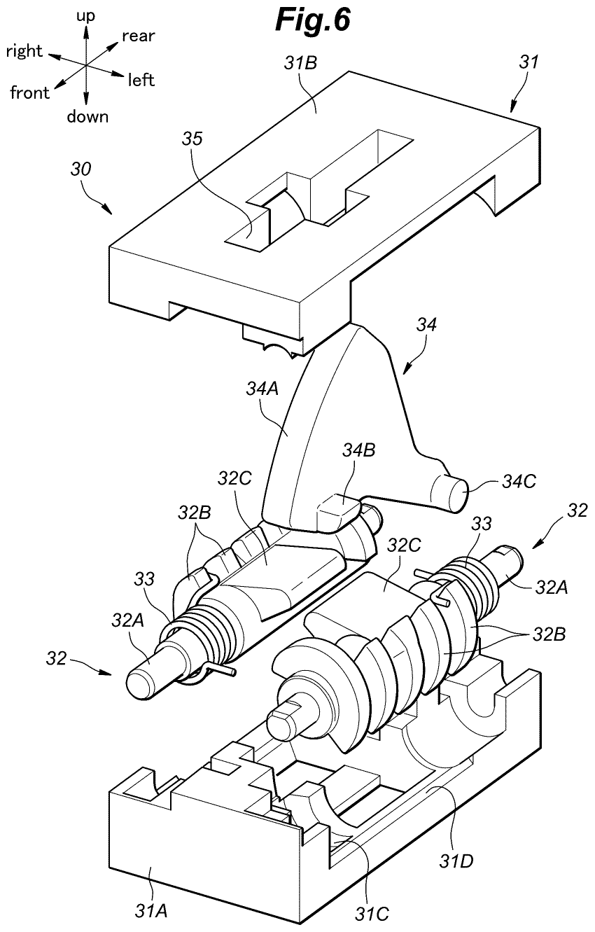

With the slider upper wall 12A and the left and right slider inner side walls 12B, the slider 12 is formed in a groove shape that is opened toward the rail bottom wall 11A, namely, downward. As shown in FIGS. 5 and 6, a slide lock device 30 is supported on the lower surface of the slider upper wall 12A.

As shown in FIGS. 5 to 10, the slide lock device 30 includes a casing 31 joined to the slider 12, at least one lock member 32 supported by the casing 31 to be rotatable between a release position and a lock position, an urging member 33 for urging the lock member 32 toward the lock position, and an operating member 34 displaceably supported by the casing 31 and contacting the lock member 32. In the present embodiment, a pair of left and right lock members 32 and a pair of left and right urging members 33 are provided.

The casing 31 is preferably formed by combining multiple casing members 31A, 31B. In the present embodiment, the casing 31 includes a lower casing member 31A and an upper casing member 31B that are joined to each other. The left and right lock members 32 are rotatably supported between the lower casing member 31A and the upper casing member 31B. The casing 31 is joined to the bottom surface of the slider upper wall 12A and is disposed between the pair of slider inner side walls 12B. Thus, the slide lock device 30 can be disposed inside the slider 12 in a space-efficient manner. Parts of the pair of slider inner side walls 12B opposing the casing 31 are formed with a slider opening 12F.

The lock members 32 are disposed in parallel with each other. Each lock member 32 has a shaft part 32A extending in the front-rear direction. Namely, the rotation axis of each lock member 32 extends in the front-rear direction. The front end and the rear end of the shaft part 32A are rotatably supported by the casing 31. Each lock member 32 includes at least one convex part 32B protruding from the shaft part 32A in a radial direction. In the present embodiment, multiple convex parts 32B protrude from the shaft part 32A on one side in the radial direction.

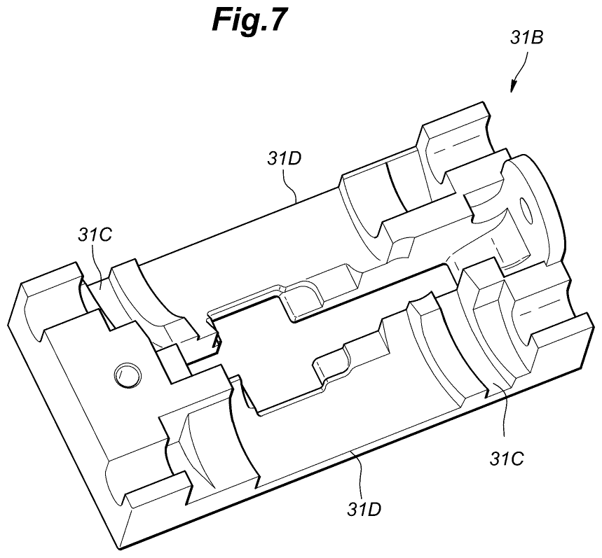

As shown in FIGS. 6 and 7, the multiple convex parts 32B preferably extend helically about the rotation axis of the lock member 32. The multiple convex parts 32B are formed intermittently from each other. The multiple convex parts 32B disposed at intervals in the front-rear direction. The casing 31 is preferably provided with helical grooves 31C for slidably receiving the multiple convex parts 32B.

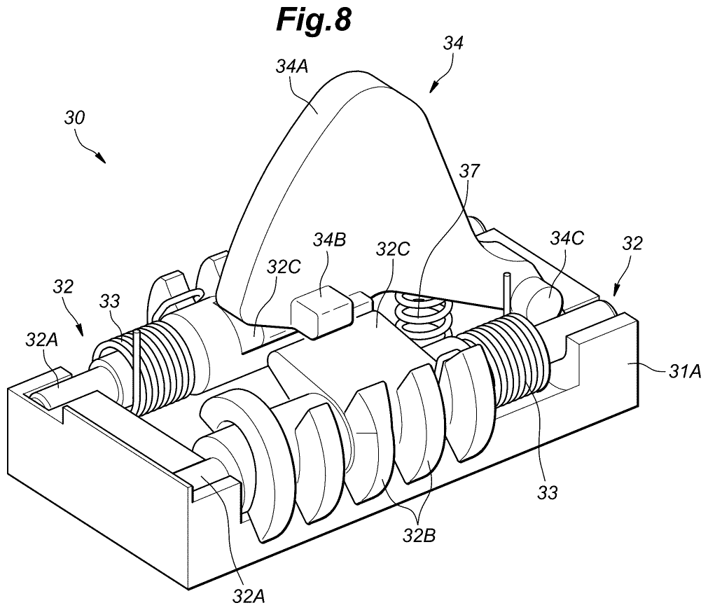

As shown in FIGS. 6 and 8, each lock member 32 includes an arm part 32C protruding from the shaft part 32A in a direction perpendicular to the rotation axis of the lock member 32. As seen in the front-rear direction, the arm part 32C extends from the shaft part 32A in a direction opposite from the convex parts 32B.

Left and right side portions of the casing 31 are each provided with a casing opening 31D. Each lock member 32 pivots between a lock position in which the multiple convex parts 32B protrude outward of the casing 31 through the casing opening 31D and a release position in which the multiple convex parts 32B are positioned within the casing 31. When the lock member 32 is in the release position, the multiple convex parts 32B are disposed above the shaft part 32A. When each of the lock members 32 is in the lock position, the pair of arm parts 32C extend laterally in directions toward each other, namely, from the respective shaft parts 32A toward the center of the casing 31. The lock position of the lock member 32 is preferably determined by at least one of the multiple convex parts 32B contacting the casing 31.

Each of the urging members 33 is provided between the casing 31 and the corresponding lock member 32 and urges the lock member 32 toward the lock position. The urging member 33 is preferably a torsion coil spring, for example. The urging member 33 is preferably supported on the shaft part 32A of the lock member 32.

The operating member 34 includes a fan-shaped main body 34A having surfaces facing leftward and rightward and a pressing part 34B provided at the lower end of the main body 34A. The operating member 34 is disposed at the center of the casing 31 in the left-right direction. At the rear end of the main body 34A, a support shaft 34C protruding in the left-right direction is provided. As seen in the left-right direction, the support shaft 34C is disposed at the center of the fan-shaped main body 34A. With the support shaft 34C rotatably supported by the casing 31, the operating member 34 is supported by the casing 31 to be pivotable about an axis extending laterally. The upper end of the main body 34A protrudes above the casing 31 by passing through an insertion hole 35 formed in the upper casing member 31B. The slider upper wall 12A of the slider 12 is formed with an operation hole 36 penetrating in the up-down direction. The upper end of the main body 34A of the operating member 34 protrudes above the slider 12 by passing through the operation hole 36. The pressing part 34B is disposed inside the casing 31. The left-right width of the pressing part 34B is formed to be larger than the left-right width of the operation hole 36. When the lock members 32 are in the lock position, the operating member 34 is in the initial position. At this time, the pressing part 34B is disposed above the left and right arm parts 32C and is in contact with the arm parts 32C. The operating member 34 may be urged toward the initial position by an urging member 37.

The left and right sliders 12 are pivotably provided with an operation lever 41. The operation lever 41 includes a lever central part 41A extending in the left-right direction below the front portion of the seat cushion 5 and left and right lever side portions 41B extending rearward from the left and right end portions of the lever central part 41A. An intermediate portion of each of the left and right lever side portions 41B in the front-rear direction is supported by the corresponding slider 12 to be pivotable about a pivot shaft 41C extending in the left-right direction. The rear ends of the left and right lever side portions 41B contact the upper ends of the operation members 34 from above. The rear ends of the left and right lever side portions 41B are preferably urged upward by urging members not shown in the drawings.

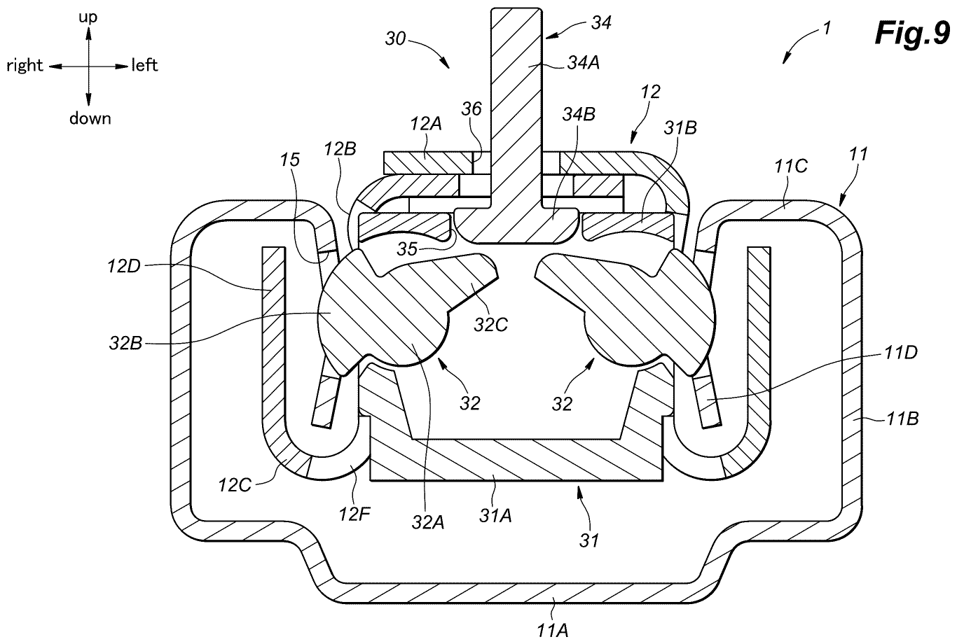

As shown in FIG. 9, when the operating member 34 is in the initial position, the left and right lock members 32 are in the lock position. When the left and right lock members 32 are in the lock position, the multiple convex parts 32B pass through the casing openings 31D and the slider openings 12F and protrude into the corresponding locking holes 15 of the rail 11 to be locked by the locking holes 15. Thereby, the movement of the slider 12 relative to the rail 11 is restricted.

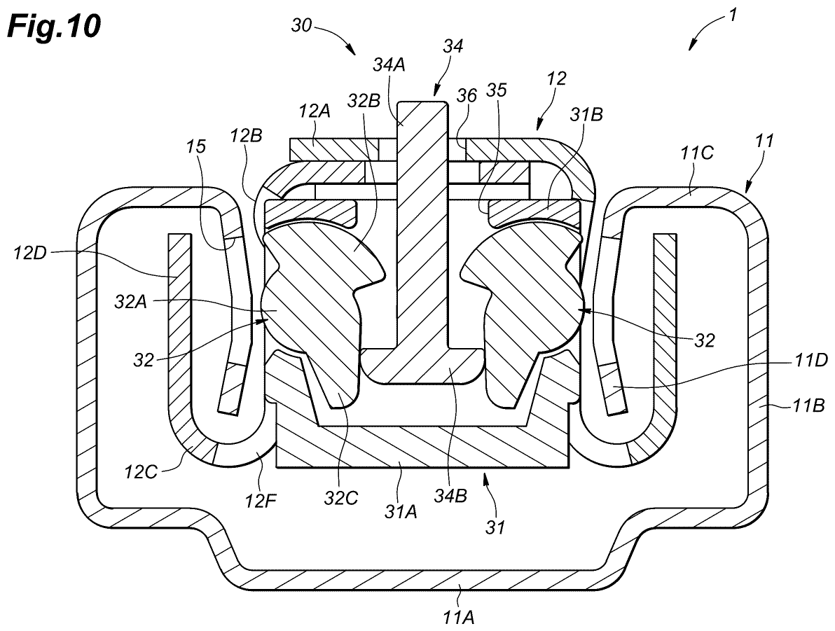

When the user pulls the lever central part 41A of the operation lever 41 upward, the rear end of each of the left and right lever side portions 41B pushes the upper end of the main body 34A downward. Thereby, as shown in FIG. 10, the operating member 34 pivots to move downward and moves from the initial position to the post-operation position. At this time, the pressing part 34B of the operating member 34 presses the lock members 32 to move the lock members 32 from the lock position to the release position. Specifically, the pressing part 34B of the operating member 34 pushes the left and right arm parts 32C downward, whereby the left and right lock members 32 pivot from the lock position to the release position. Consequently, the multiple convex parts 32B are separated from the locking holes 15 of the rail 11 and move to the inside of the casing 31. Thereby, the slider 12 becomes movable relative to the rail 11.

The operating member 34 presses the arm parts 32C in a first direction parallel to a tangential direction about the rotation axis of the lock member 32, and each arm part 32C and the operating member 34 have no overlap in the first direction when the lock members 32 reach the release position. In the present embodiment, the first direction is the up-down direction. According to this aspect, even when an excessive load is applied to each operating member 34, the load is not transmitted to the arm part 32C. Therefore, fracture of each lock member 32 is prevented.

When each lock member 32 is moved from the lock position to the release position, at least one of the convex parts 32B slides in the helical groove 31C, whereby the lock member 32 can smoothly rotate from the lock position to the release position.

In the slide lock device 30, the lock members 32 are rotatably supported by the casing 31, and therefore, when the lock members 32 are pushed by the operating member 34, the lock members 32 can smoothly move from the lock position to the release position. Thus, the slide lock device 30 capable of operating smoothly can be provided.

When the lock members 32 are in the lock position, the multiple convex parts 32B protrude from the casing 31, and when the lock members 32 are in the release position, the multiple convex parts 32B are positioned inside the casing 31, and thus, the gap between the casing 31 and the rail 11 can be made small.

Since the pair of lock members 32 are disposed in parallel with each other and the operating member 34 contacts each of the pair of arm parts 32C, the lock members 32 can be engaged with the rail 11 with good stability.

An assembly method for the slide device 1 described above includes a step of assembling the slide lock device 30 by mounting the lock members 32, the urging members 33, and the operating member 34 to the casing 31, a step of mounting the casing 31 to the slider 12, and a step of mounting the slider 12 to the rail 11. According to this aspect, it is possible to assemble the slide lock device 30 to the inner side of the slider 12 in a work-efficient manner. Also, the step of assembling the slide lock device 30 includes a step of mounting the urging members 33 to the lock members 32, a step of making one of the multiple casing members support the lock members 32 to which the urging members 33 are mounted and the operating member 34, and a step of joining the multiple casing members to each other. The multiple casing members include the lower casing member 31A and the upper casing member 31B.

### Second Embodiment

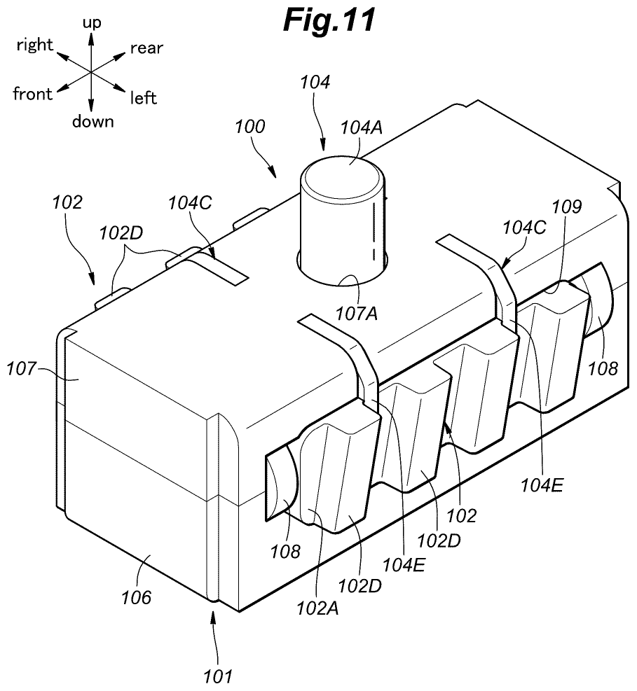

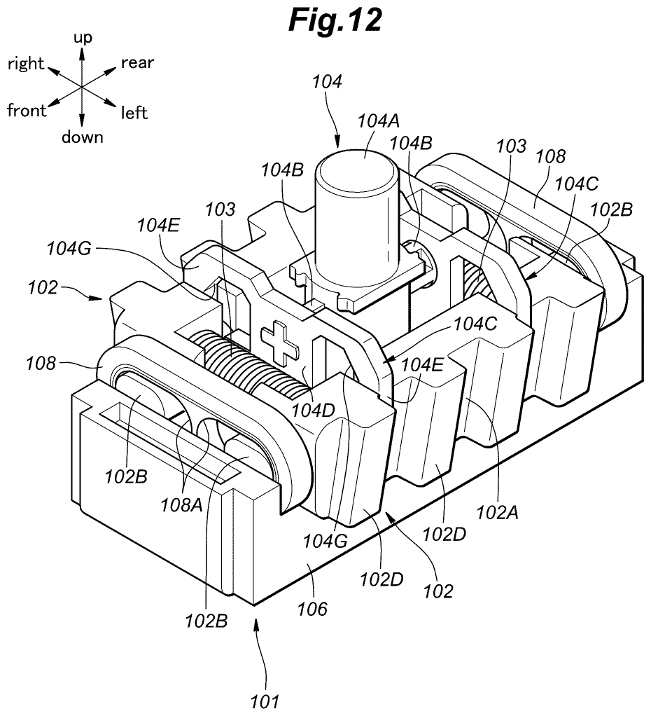

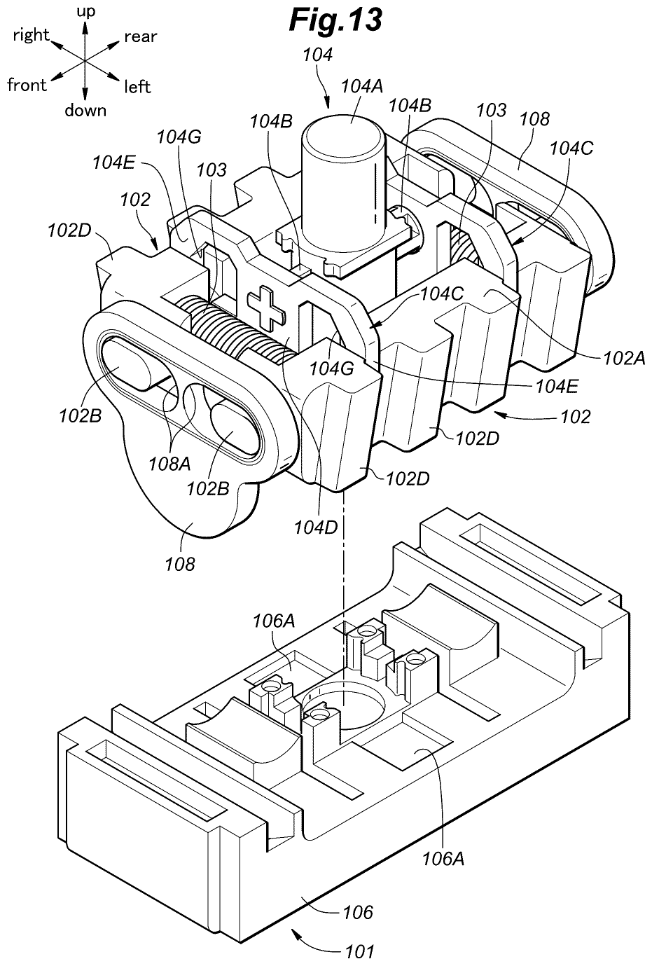

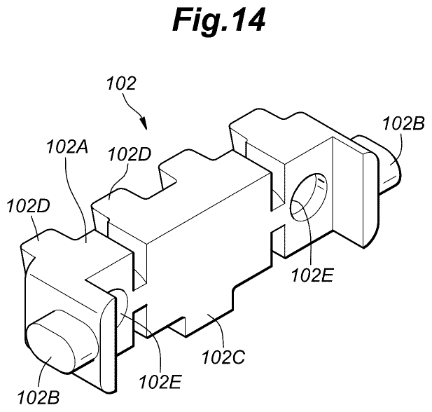

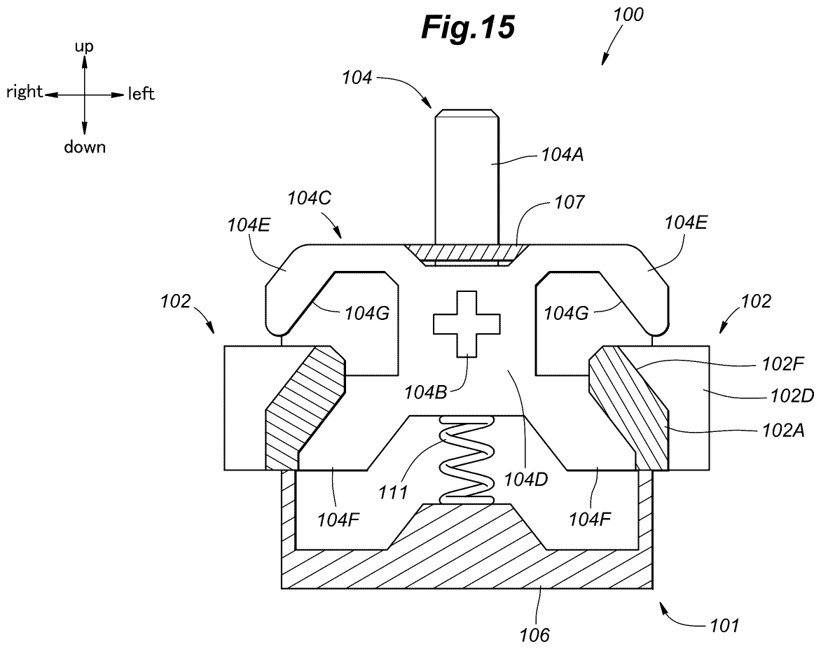

FIGS. 11 to 15 show a slide lock device 100 according to the second embodiment. The slide lock device 100 according to the second embodiment differs from the slide lock device 30 according to the first embodiment with respect to the configurations of the casing 31, the lock members 32, the operating member 34, the urging members 33, etc. The configurations of the rail 11 and the slider 12 to which the slide lock device 100 is provided are the same as in the first embodiment, and thus, they are denoted by the same reference signs and the description thereof will be omitted.

The slide lock device 100 includes a casing 101 joined to the slider 12, left and right lock members 102 supported by the casing 101 to be slidingly movable between the release position and the lock position, a pair of front and rear urging members 103 for urging the lock members 102 toward the lock position, and an operating member 104 displaceably supported by the casing 101 and contacting the lock members 102.

The casing 101 includes a lower casing member 106, an upper casing member 107, and a pair of front and rear guide members 108. The lower casing member 106 and the upper casing member 107 are joined to each other and form an outer shell of the casing 101 which is hollow. Left and right side portions of the casing 101 are each formed with a casing opening 109.

The pair of guide members 108 is sandwiched by the lower casing member 106 and the upper casing member 107. Each guide member 108 is formed with a pair of left and right guide holes 108A. Each guide hole 108A penetrates the guide member 108 in the front-rear direction and extends laterally.

The pair of left and right lock members 102 are disposed in parallel with each other. Each lock member 102 includes a main body 102A extending in the front-rear direction. Guide shafts 102B are provided at the front end and the rear end of the main body 102A, respectively. Each guide shaft 102B is engaged with one of the guide holes 108A formed in the front and rear guide members 108. Due to the front and rear guide members 108, the left and right lock members 102 are supported by the casing 101 to be slidingly movable in the left-right direction. Also, a lower portion of each main body 102A is provided with a guide convex part 102C that protrudes downward. An upper surface of the lower casing member 106 is formed with guide grooves 106A that extend laterally. The left and right guide convex parts 102C are engaged with the guide grooves 106A.

Each lock member 102 includes multiple convex parts 102D protruding laterally outward from the main body 102A. An inner side surface of each main body 102A is formed with a pair of front and rear receiving holes 102E. Each urging member 103 is a compression coil spring that extends laterally. The left end and the right end of the urging member 103 on the front side are received in the left and right receiving holes 102E disposed on the front side. The left end and the right end of the urging member 103 on the rear side are received in the left and right receiving holes 102E disposed on the rear side. The urging members 103 urge the lock members 102 in directions away from each other.

Each lock member 102 slidingly moves between a lock position in which the multiple convex parts 102D protrude outward of the casing 101 through the casing opening 31D and a release position in which the multiple convex parts 102D are positioned within the casing 101. The lock position and the release position of each lock member 102 are defined by the guide members 108. When the lock members 102 are in the lock position, the slide lock device 100 is in the locked state, and when the lock members 102 are in the release position, the slide lock device 100 is in the release state. Each lock member 102 is urged toward the lock position by the urging members 103.

The operating member 104 includes an operating shaft 104A extending in the up-down direction, a connecting shaft 104B extending in the front-rear direction from a lower portion of the operating shaft 104A, and a pair of front and rear cam members 104C joined to the front end and the rear end of the connecting shaft 104B. The upper end of the operating shaft 104A protrudes above the casing 101 by passing through an operation hole 107A formed in an upper portion of the upper casing member 107. The operating member 104 is supported by the casing 101 to be slidingly movable in the up-down direction. The front and rear cam members 104C are disposed between the front and rear urging members 103.

Each cam member 104C includes a central part 104D joined to the connecting shaft 104B, left and right cam arm parts 104E extending from the upper end of the central part 104D laterally outward and downward, and stopper parts 104F extending laterally outward from the lower end of the central part 104D. A tip end portion of each cam arm part 104E is provided with a cam surface 104G facing laterally inward and downward. An upper portion of the main body 102A of each of the left and right lock members 102 is provided with a pair of front and rear cam surfaces 102F facing laterally outward and upward. A pair of front and rear cam surfaces 104G opposes the corresponding pair of cam surfaces 102F.

The operating member 104 is movable between an initial position and a post-operation position which is located below the initial position. Between the lower end of the operating shaft 104A and the casing 101, an urging member (not shown in the drawings) is provided. With the urging member, the operating member 104 is urged toward the initial position.

When the operating member 104 is in the initial position, the cam surfaces 104G are spaced upward from the cam surfaces 102F. At this time, each stopper part 104F of the operating member 104 pushes the inner side surface of the main body 102A of the corresponding lock member 102 laterally outward, and each lock member 102 is maintained in the lock position. The left and right side portions of each stopper part 104F are preferably inclined upward and laterally inward. When the left and right lock members 102 are in the lock position, the multiple convex parts 102D protrude into the corresponding locking holes 15 of the rail 11 by passing through the casing opening 109 and the slider opening 12F and are locked to the locking holes 15. Thereby, the movement of the slider 12 relative to the rail 11 is restricted.

The upper end of the operating shaft 104A is in contact with the rear end of one of the lever side portions 41B of the operation lever 41. When the user pulls the lever central part 41A of the operation lever 41 upward, the rear end of each of the left and right lever side portions 41B pushes the upper end of the operating shaft 104A downward. Accordingly, the operating member 104 slidingly moves downward and moves from the initial position to the post-operation position. At this time, each stopper part 104F of the operating member 104 is separated from each main body 102A, and each lock member 102 becomes movable from the lock position to the release position.

When the operating member 104 is moved further downward toward the post-operation position, each cam surface 104G pushes the corresponding cam surface 102F downward and laterally inward. Thereby, the left and right lock members 102 move from the lock position to the release position. Consequently, the multiple convex parts 102D are separated from the locking holes 15 of the rail 11 and move to the inside of the casing 101. Thereby, the slider 12 becomes movable relative to the rail 11.

An angle of each cam surface 104G and an angle of each cam surface 102F with respect to the water surface (the surface perpendicular to the axis of the operating shaft 104A) are preferably greater than or equal to 16 degrees and less than or equal to 27 degrees, more preferably greater than or equal to 20 degrees and less than or equal to 25 degrees. Thereby, a large stroke of the operating member 104 can be achieved. Accordingly, a large stroke of each lock member 102 can be achieved, and a large protrusion length of each convex part 102D into the locking hole 15 can be achieved. Also, a large distance between each convex part 102D and the locking hole 15 when the lock member 102 is in the release position can be achieved.

### Third Embodiment

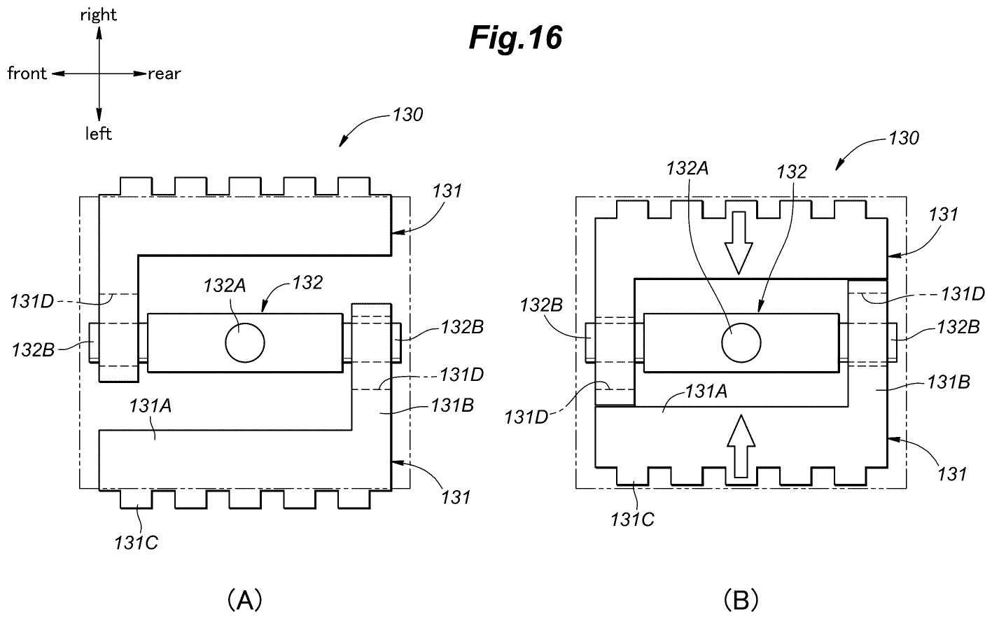

As shown in FIGS. 16 to 18, a slide lock device 130 according to the third embodiment differs from the slide lock device 100 according to the second embodiment with respect to the configurations of the lock members 102 and the operating member 104. In the slide lock device 130, configurations same as those of the slide lock device 100 are denoted by the same reference signs and the description thereof will be omitted.

In the slide lock device 130, left and right lock members 131 are supported by the casing 101 to be slidingly movable in the left-right direction. Also, an operating member 132 is supported by the casing 101 to be slidingly movable in the up-down direction.

Each lock member 131 includes a main body 131A extending in the front-rear direction and a connection part 131B extending from the front end or the rear end of the main body 131A in the left-right direction toward the center of the casing 101. Multiple convex parts 131C are provided on a side surface of the main body 131A. The configurations of the main body 131A and the convex parts 131C may be the same as those of the main body 102A and the convex parts 102D.

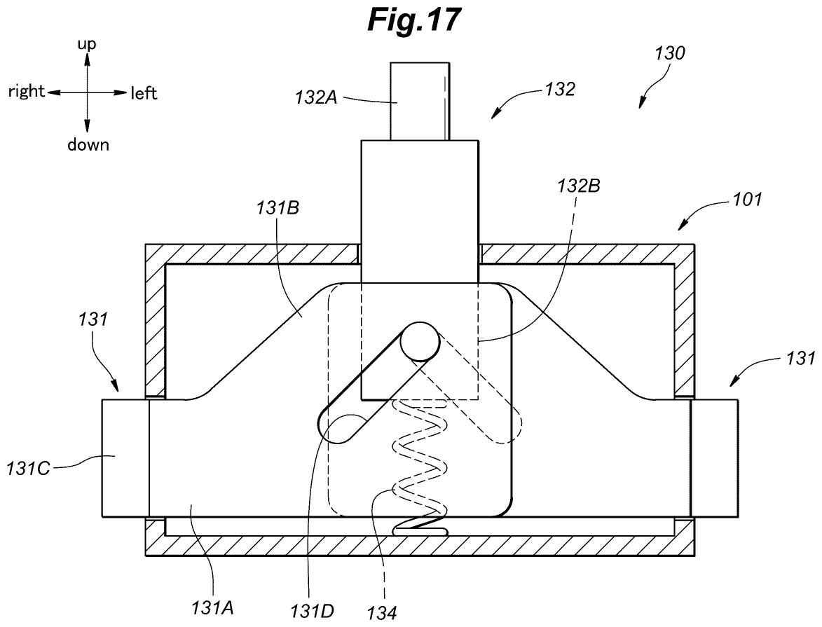

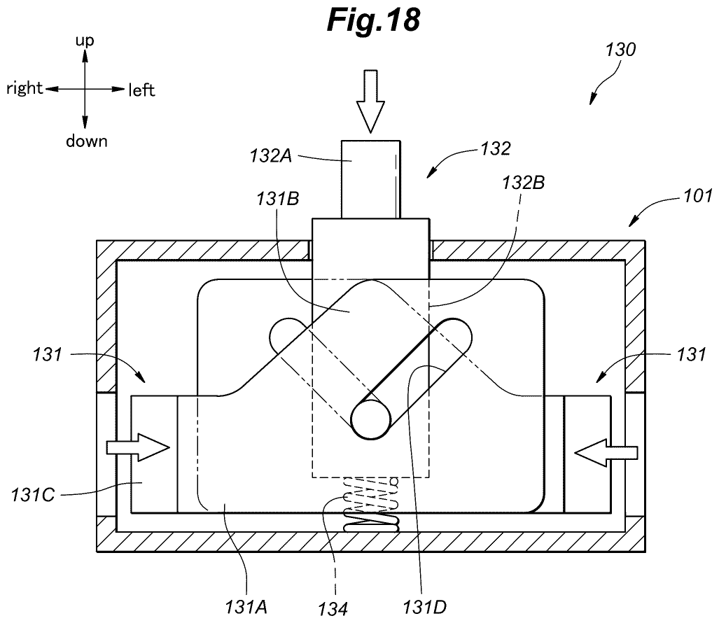

Preferably, in one lock member 131, the connection part 131B is provided at the front end of the main body 131A, and in the other lock member 131, the connection part 131B is provided at the rear end of the main body 131A. Each connection part 131B is formed with a cam groove 131D. As shown in FIGS. 17 and 18, the cam groove 131D extends upward from the side of the main body 131A toward the protruding end of the connection part 131B. In the present embodiment, the cam groove 131D extends linearly. The cam groove 131D penetrates the connection part 131B in the front-rear direction.

The left and right lock members 131 are movable between a lock position in which the multiple convex parts 131C protrude from the casing 101 laterally outward and a release position in which the multiple convex parts 131C are retracted into the casing 101.

The operating member 132 includes an operating shaft 132A extending in the up-down direction and a connecting shaft 132B extending forward and rearward from the lower end of the operating shaft 132A. The upper end of the operating shaft 132A protrudes upward from the casing 101. The connecting shaft 132B is disposed inside the casing 101. The operating member 132 is supported by the casing 101 to be movable in the up-down direction.

The front end of the connecting shaft 132B is engaged with the cam groove 131D of one of the left and right lock members 131. The rear end of the connecting shaft 132B is engaged with the cam groove 131D of the other of the left and right lock members 131. When the left and right lock members 131 are in the lock position, the operating member 132 is positioned in the initial position.

The slide lock device 130 includes an urging member 134 for urging the left and right lock members 131 toward the lock position. The urging member 134 may be a compression coil spring, for example. The urging member 134 may be provided between the left and right main bodies 131A, for example. The urging member 134 may urge the left and right lock members 131 toward the lock position via the operating member 132.

A state in which the left and right lock members 131 are in the lock position is referred to as a locked state of the slide lock device 130. A state in which the left and right lock members 131 are in the release position is referred to as a release state of the slide lock device 130. When the slide lock device 130 is in the locked state, the left and right multiple convex parts 131C protrude laterally outward of the casing 101 and are locked in the multiple locking holes 15 of the rail 11. Thereby, the movement of the slider 12 relative to the rail 11 is restricted. When the slide lock device 130 is in the release state, the left and right multiple convex parts 131C are retracted into the casing 101 and are separated from the multiple locking holes 15 of the rail 11. Thereby, the movement of the slider 12 relative to the rail 11 is enabled.

When the user operates the operation lever 41, the rear end of each lever side portion 41B of the operation lever 41 pushes the upper end of the operating shaft 132A downward, and the operating member 132 moves downward. Consequently, the front end and the rear end of the connecting shaft 132B push the corresponding cam grooves 131D downward, and thus, the left and right lock members 131 move to the release position.

Compared to the slide lock device 100 according to the second embodiment, in the slide lock device 130 according to the third embodiment, the guide members 108 and the cam member 104C can be omitted, and thus, the number of components can be reduced. Also, as in the slide lock device 100 according to the second embodiment, a large stroke of the lock members 131 can be achieved in the slide lock device 130 according to the third embodiment.

### Fourth Embodiment

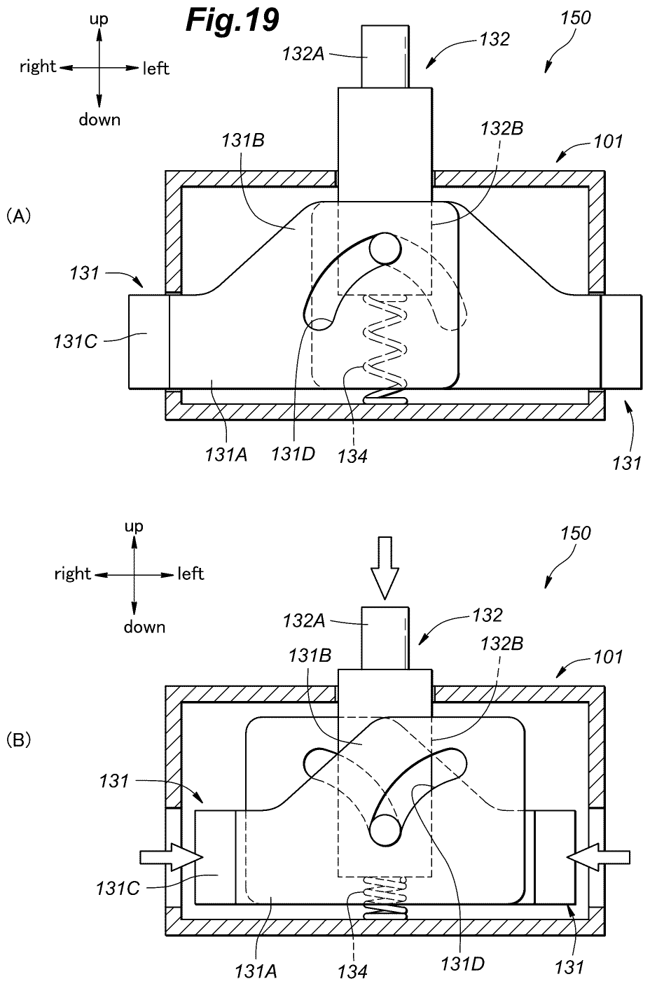

As shown in FIG. 19, a slide lock device 150 according to the fourth embodiment differs from the slide lock device 130 according to the third embodiment with respect to the shape of the cam grooves 131D. Each cam groove 131D extends in an arc shape from the side of the main body 131A toward the protruding end of the connection part 131B. Each cam groove 131D is formed in an arc shape that is convex forward and laterally outward. Therefore, the operating member 132 requires a relatively large operating force when starting moving from the initial state toward the post-operation position and the necessary operating force becomes smaller as it approaches the post-operation position.

### Fifth Embodiment

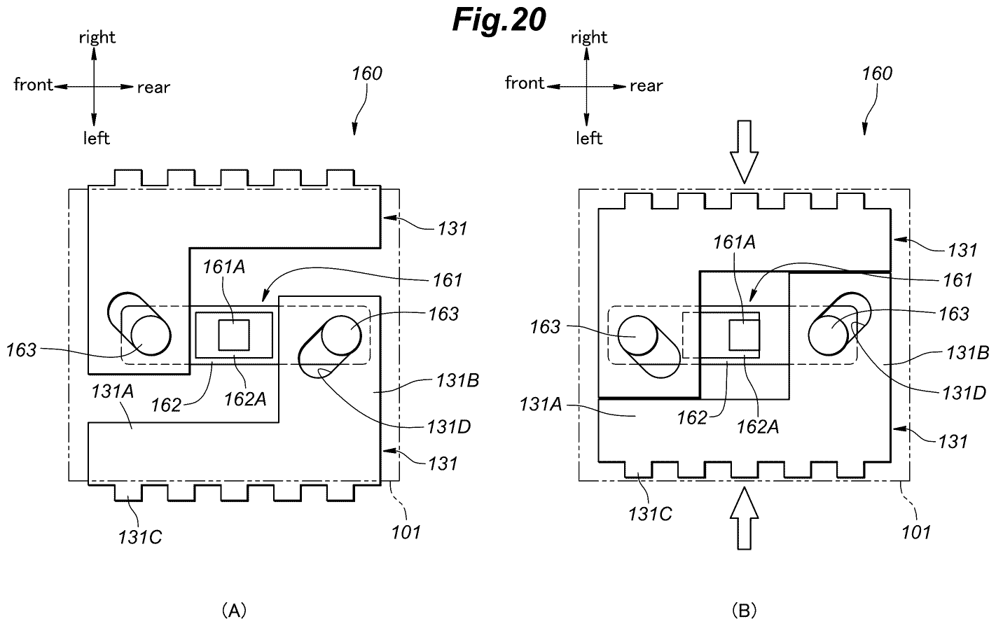

As shown in FIG. 20, a slide lock device 160 according to the fifth embodiment differs from the slide lock device 130 according to the third embodiment with respect to the connection part 131B of each lock member 131 and the operating member 132. The front and rear connection parts 131B are each formed with a cam groove 131D penetrating in the up-down direction. As seen from above, each cam groove 131D extends rearward from side of the main body 131A toward the protruding end of the connection part 131B.

An operating member 161 includes an operating shaft 161A provided in the casing 101 to be movable in the up-down direction, a transmission member 162 extending in the front-rear direction and provided in the casing 101 to be movable in the front-rear direction, and pins 163 provided at the front end and the rear end of the transmission member 162. Each pin 163 protrudes into the corresponding cam groove 131D.

The transmission member 162 is provided with a cam surface 162A slidably contacting the lower end of the operating shaft 161A. The cam surface 162A is preferably inclined downward toward the rear. When the operating shaft 161A is moved downward, the lower end of the operating shaft 161A pushes the cam surface 162A and the transmission member 162 moves forward. At this time, each pin 163 pushes the corresponding cam groove 131D, whereby the lock member 131 moves from the lock position to the release position.

### Sixth Embodiment

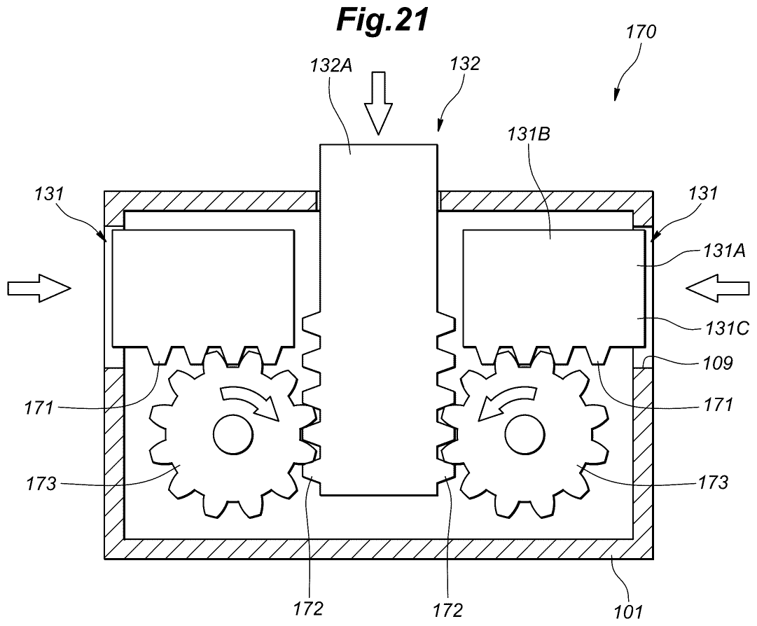

As shown in FIG. 21, a slide lock device 170 according to the sixth embodiment differs from the slide lock device 130 according to the third embodiment with respect to the lock members 131 and the operating member 132. Each lock member 131 includes a first rack 171 extending in the left-right direction. The operating member 132 includes an operating shaft 132A extending in the up-down direction, left and right second racks 172 provided on the left and right side surfaces of the operating shaft 132A and extending in the up-down direction, and left and right pinions 173 rotatably supported by the casing 101. The left pinion 173 meshes with the left first rack 171 and the left second rack 172. The right pinion 173 meshes with the right first rack 171 and the right second rack 172.

When the operating shaft 132A is in the initial position, the left and right lock members 131 are in the lock position. When the operating shaft 132A moves from the initial position to the post-operation position, the left and right pinions 173 which are engaged with the left and right second racks 172 rotate. Thereby, the left and right lock members 131 having the first racks 171 engaged with the respective pinions 173 move from the lock position to the release position.

### Seventh Embodiment

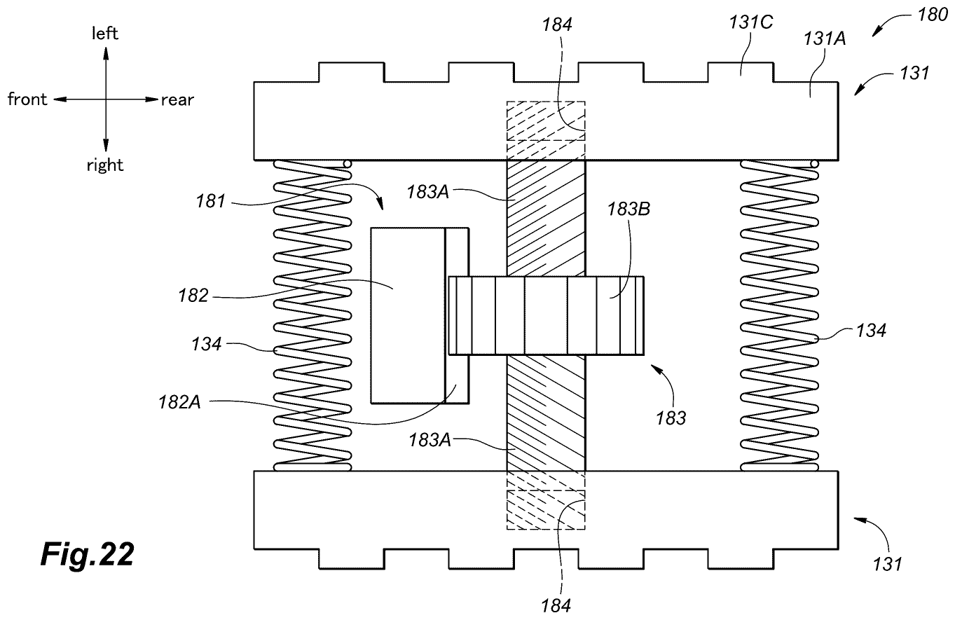

As shown in FIG. 22, a slide lock device 180 according to the seventh embodiment differs from the slide lock device 130 according to the third embodiment with respect to the lock members 131 and the operating member 132. An operating member 181 includes an operating shaft 182 and a screw shaft 183. The operating shaft 182 extends in the up-down direction and is supported by the casing 101 to be slidingly movable in the up-down direction. The upper end of the operating shaft 182 protrudes upward from the casing 101. A lower portion of the operating shaft 182 is provided with a rack 182A extending in the up-down direction. The screw shaft 183 extends laterally, and each of the left end and the right end thereof is formed with a male thread 183A. The left and right male threads 183A have different rotation directions (screw directions). The mutually opposing surfaces of the main bodies 131A of the left and right lock members 131 are each formed with a female threaded hole 184 extending in the left-right direction. The left and right male threads 183A of the screw shaft 183 are threadedly engaged with the laterally corresponding female threaded holes 184. At a central part of the screw shaft 183, a pinion 183B engaged with the rack 182A is provided.

The upper end of the operating shaft 182 is in contact with the rear end of one of the lever side portions 41B of the operation lever 41. When the user operates the operation lever 41, the operating shaft 182 is pushed downward by the operation lever 41, and the operating shaft 182 moves downward. Consequently, the pinion 183B engaged with the rack 182A rotates, and the screw shaft 183 rotates. As a result, the left and right male threads 183A are threadedly advanced relative to the corresponding female threaded holes 184, whereby the left and right lock members 131 move in directions toward each other. Namely, the left and right lock members 131 move from the lock position to the release position. When the user stops the operation of the operation lever 41, the left and right lock members 131 move from the release position to the lock position due to the urging force of the urging member 134, and the operating shaft 182 moves to the initial position.

### Eighth Embodiment

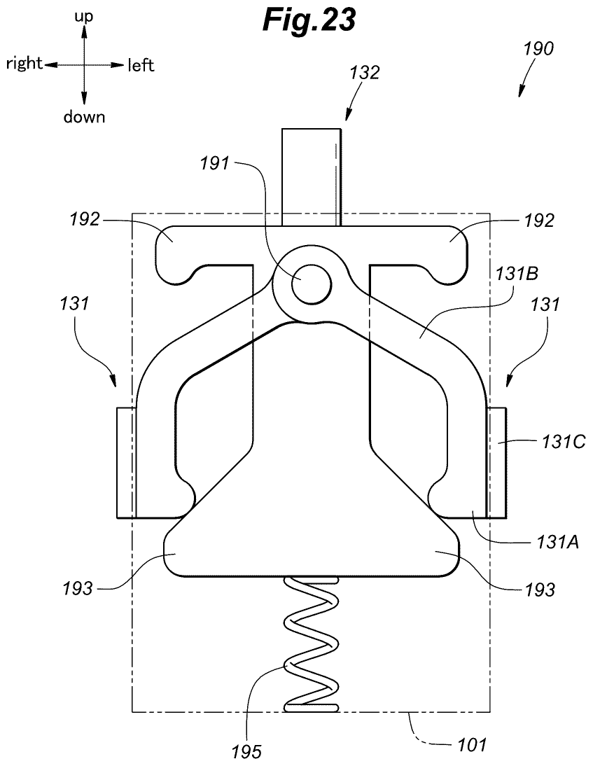

As shown in FIG. 23, a slide lock device 190 according to the eighth embodiment differs from the slide lock device 130 according to the third embodiment with respect to the lock members 131 and the operating member 132. The left and right lock members 131 are pivotably supported on a support shaft 191 supported by the casing 101 and are displaceable between the lock position and the release position. The support shaft 191 is provided in an upper part of the casing 101 and extends in the front-rear direction. In each of the left and right lock members 131, the connection part 131B extends upward and laterally inward from the upper portion of the main body 131A. Each of the left and right connection parts 131B has a width in the front-rear direction. The upper end of each connection part 131B is pivotably supported on the support shaft 191.

The operating member 132 includes an operating shaft 132A extending in the up-down direction, and left and right arms 192 and left and right stoppers 193 provided on the operating shaft 132A. The operating member 132 is preferably provided in front of and behind the support shaft 191. The operating shaft 132A is supported by the casing 101 to be displaceable in the up-down direction. The upper end of the operating shaft 132A protrudes above the casing 101. The left and right stoppers 193 protrude to the left and right from the lower end of the operating shaft 132A. The left and right arms 192 are disposed inside the casing 101 and protrude to the left and right from an upper portion of the operating shaft 132A. Between the lower end of the operating shaft 132A and the casing 101, an urging member 195 for urging the operating shaft 132A upward (toward the initial position) is provided.

When the operating member 132 is in the initial position, the left and right stoppers 193 contact the inner side surfaces of the main bodies 131A of the left and right lock members 131 and maintain the left and right lock members 131 in the lock position. When the user operates the operation lever 41, the operating shaft 132A is pushed downward by the operation lever 41, and the operating shaft 132A moves downward. Consequently, the left and right stoppers 193 are separated from the corresponding main bodies 131A, whereby the left and right lock members 131 become movable to the release position. In the state, when the operating member 132 is moved further downward, the left and right arms 192 push the corresponding connection parts 131B downward. Thereby, the left and right lock members 131 pivot about the support shaft 191 and move from the lock position to the release position. Consequently, the left and right lock members 131 are separated from the locking holes 15 of the rail 11, whereby the slider 12 becomes movable relative to the rail 11. When the user stops the operation of the operation lever 41, the left and right lock members 131 return to the lock position due to the urging force of the urging member 134, and the operating member 132 returns to the initial position due to the urging force of the urging member 195.

### Ninth Embodiment

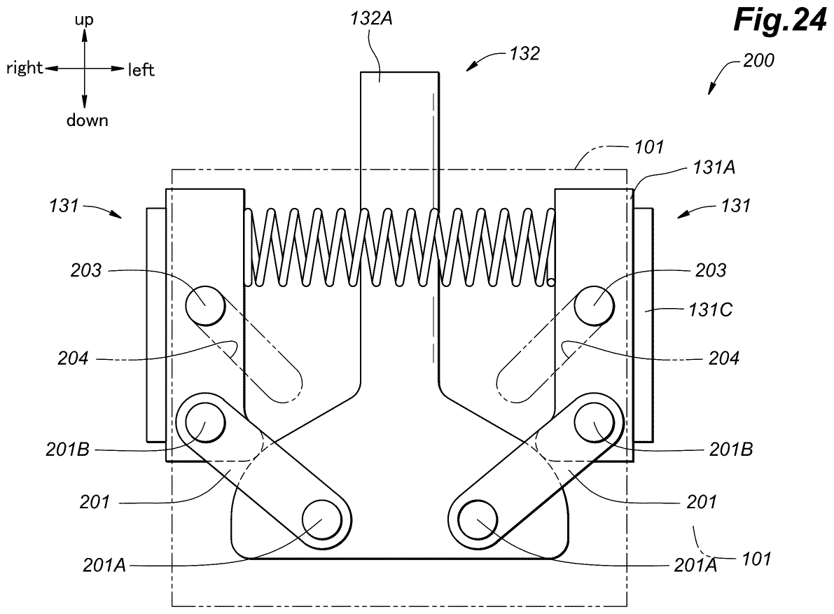

As shown in FIG. 24, a slide lock device 200 according to the ninth embodiment differs from the slide lock device 130 according to the third embodiment with respect to the lock members 131 and the operating member 132. The operating shaft 132A of the operating member 132 is connected to the left and right lock members 131 by left and right links 201. Each link 201 includes a first shaft 201A pivotably joined to the operating shaft 132A and a second shaft 201B pivotably joined to the lock member 131. The first shaft 201A and the second shaft 201B extend in parallel with each other in the front-rear direction.

At least one of the front end and the rear end of the main body 131A of the lock member 131 is provided with a guide pin 203 protruding in the front-rear direction. The casing 101 is formed with left and right guide slots 204 for slidably receiving the left and right guide pins 203. Each guide slot 204 is inclined downward toward laterally inside.

When the user operates the operation lever 41, the operating shaft 132A is pushed downward by the operation lever 41 and the operating shaft 132A moves downward. Consequently, the left and right lock members 131 connected to the operating shaft 132A via the links 201 move from the lock position to the release position. Namely, the left and right lock members 131 are pulled by the operating shaft 132A to move laterally inward of the casing 101. At this time, since the left and right guide pins 203 are guided by the left and right guide slots 204, tilting of the left and right lock members 131 is suppressed.

### Tenth Embodiment

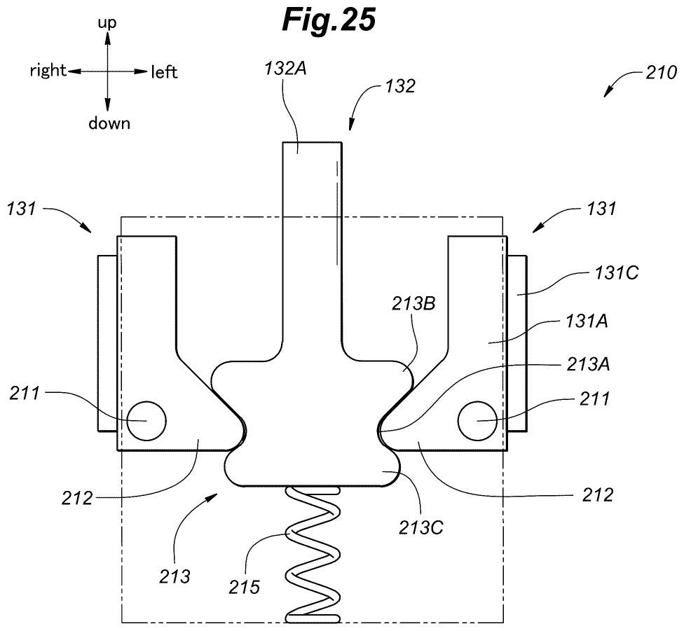

As shown in FIG. 25, a slide lock device 210 according to the tenth embodiment differs from the slide lock device 130 according to the third embodiment with respect to the lock members 131 and the operating member 132. Each of the left and right lock members 131 includes pivot shafts 211 protruding forward and rearward from lower portions of the front end and the rear end of the main body 131A and an arm part 212 extending laterally inward from a lower portion of the main body 131A. The front and rear pivot shafts 211 are pivotably supported by the casing 101. Thereby, the left and right lock members 131 pivot about the front and rear pivot shafts 211 between the lock position and the release position. The left and right main bodies 131A are urged toward the lock position by an urging member 134.

The operating member 132 includes an operating shaft 132A extending in the up-down direction and a cam 213 provided at the lower end of the operating shaft 132A. The cam 213 includes a pair of left and right recessed parts 213A in an intermediate portion in the up-down direction. The left and right recessed parts 213A are recessed laterally inward from the left and right side surfaces of the cam 213. The cam 213 includes a pair of left and right upper convex parts 213B protruding laterally outward above the left and right recessed parts 213A and includes a pair of left and right lower convex parts 213C protruding laterally outward below the left and right recessed parts 213A. Each recessed part 213A and the corresponding upper convex part 213B are connected by a smooth curved surface. Each recessed part 213A and the corresponding lower convex part 213C are connected by a smooth curved surface. The operating member 132 is urged toward the initial position by an urging member 215.

When the operating member 132 is in the initial position, the arm parts 212 of the left and right lock members 131 are within the corresponding recessed parts 213A, and the left and right lock members 131 are in the lock position. When the user operates the operation lever 41, the operating shaft 132A is pushed downward by the operation lever 41, and the operating shaft 132A moves downward. At this time, since the left and right upper convex parts 213B push the corresponding arm parts 212 downward, the left and right lock members 131 pivot toward the release position. Then, when the operating member 132 reaches the post-operation position, the left and right lock members 131 reach the release position.

### Eleventh Embodiment

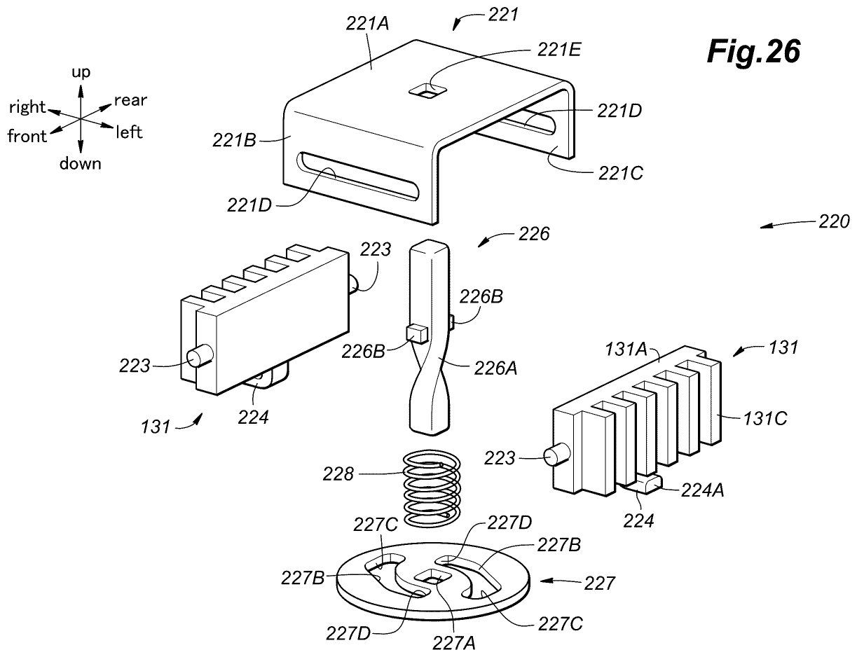

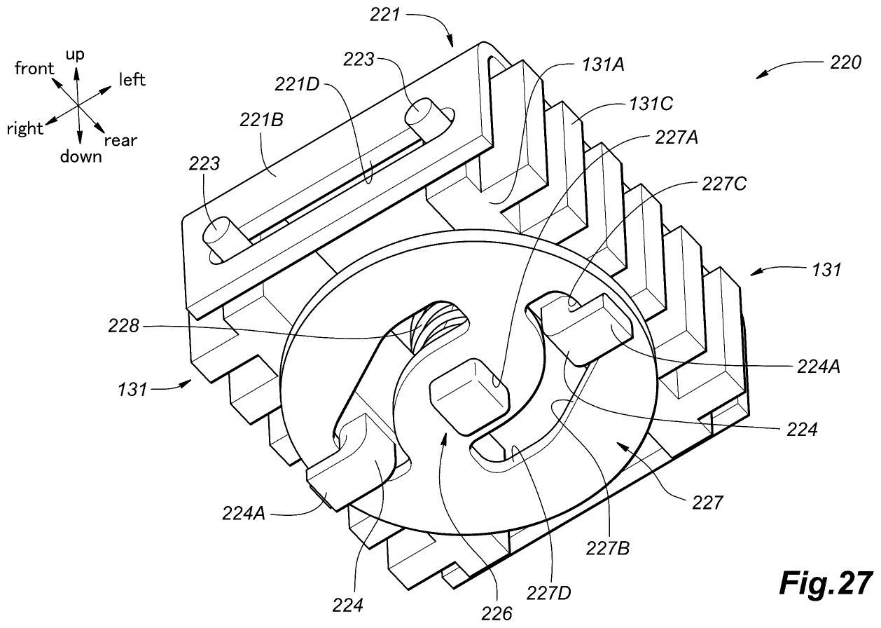

As shown in FIGS. 26 and 27, a slide lock device 220 according to the eleventh embodiment differs from the slide lock device 130 according to the third embodiment with respect to the casing 101, the lock members 131, and the operating member 132. A casing 221 includes an upper wall 221A having surfaces facing upward and downward, a front wall 221B extending downward from the front edge of the upper wall 221A and having surfaces facing forward and rearward, and a rear wall 221C extending downward from the rear edge of the upper wall 221A and having surfaces facing forward and rearward. Each of the front wall 221B and the rear wall 221C is formed with a guide slot 221D penetrating in the front-rear direction and extending laterally. At the center of the upper wall 221A, a polygonal hole 221E penetrating in the up-down direction is formed. The polygonal hole 221E is preferably formed in a quadrilateral shape.

Each of the front end and the rear end of the main body 131A of each of the left and right lock members 131 is provided with a first guide pin 223 protruding in the front-rear direction. The front and rear first guide pins 223 are received in the corresponding guide slots 221D. Thereby, the left and right lock members 131 are supported by the casing 101 to be slidingly movable left and right between the lock position and the release position. At the lower end of each main body 131A, a guide arm 224 extending downward is provided. A lower end portion of each guide arm 224 is provided with a locking part 224A that is bent laterally outward.

The operating member 132 includes an operating shaft 226, a cam plate 227, and an urging member 228. The operating shaft 226 extends in the up-down direction. The operating shaft 226 is formed in a polygonal pillar shape. In the present embodiment, the operating shaft 226 has a quadrilateral cross section. The operating shaft 226 includes a twisted part 226A in an intermediate portion in the up-down direction. At the twisted part 226A, the operating shaft 226 is twisted 90 degrees about an axis extending in the up-down direction. The operating shaft 226 includes stoppers 226B protruding sideways from a portion above the twisted part 226A.

An upper portion of the operating shaft 226 is inserted into the polygonal hole 221E to be movable in the up-down direction. The operating shaft 226 is engaged with the polygonal hole 221E, whereby rotation about an axis extending in the up-down direction is restricted. The stoppers 226B are disposed below the upper wall 221A. The stoppers 226B determine the initial position of the operating shaft 226 by contacting the upper wall 221A. The upper end of the operating shaft 226 is in contact with the rear end of one of the lever side portions 41B of the operation lever 41.

The cam plate 227 is a plate-shaped member having surfaces facing upward and downward. The cam plate 227 is preferably formed in a circular shape. At the center of the cam plate 227, an insertion hole 227A penetrating in the up-down direction is formed. A pair of cam slots 227B is formed around the insertion hole 227A of the cam plate 227. The pair of cam slots 227B is formed to be rotationally symmetrical about the axis of the cam plate 227. Each cam slot 227B penetrates the cam plate 227 in the up-down direction. The cam slot 227B extends in the circumferential direction of the cam plate 227 and has a first end 227C and a second end 227D. The distance between the first end 227C and the center of the cam plate 227 is greater than the distance between the second end 227D and the center of the cam plate 227.

The lower portion of the operating shaft 226 is inserted in the insertion hole 227A to be movable in the up-down direction. The insertion hole 227A is engaged with the lower portion of the operating shaft 226, and thereby is nonrotatable relative to the operating shaft 226.

In each cam slot 227B, the guide arm 224 of the corresponding lock member 131 is inserted. With the main body 131A and the locking part 224A of each lock member 131, the movement of the cam plate 227 in the up-down direction relative to each lock member 131 is restricted.

The urging member 228 is provided between the stoppers 226B and the cam plate 227. The urging member 228 may be a compression coil spring. The urging member 228 urges the operating shaft 226 upward relative to the cam plate 227. Namely, the urging member 228 urges the operating shaft 226 toward the initial position.

When the operating shaft 226 is in the initial position, the lower portion of the operating shaft 226 is positioned in the insertion hole 227A. At this time, each of the left and right guide arms 224 is positioned in the first end 227C of the corresponding cam slot 227B. Consequently, the left and right lock members 131 are in the lock position in which they are distant from each other in the left-right direction.

When the user operates the operation lever 41, the operating shaft 226 is pushed downward by the operation lever 41, and the operating shaft 226 moves downward. Consequently, the operating shaft 132A moves downward relative to the cam plate 227, and the twisted part 226A enters the insertion hole 227A. Consequently, the cam plate 227 rotates, and each of the left and right guide arms 224 moves in the corresponding cam slot 227B from the first end 227C to the second end 227D. Thereby, the left and right lock members 131 move in directions toward each other in the left-right direction. Namely, the left and right lock members 131 move from the lock position to the release position.

### Twelfth Embodiment

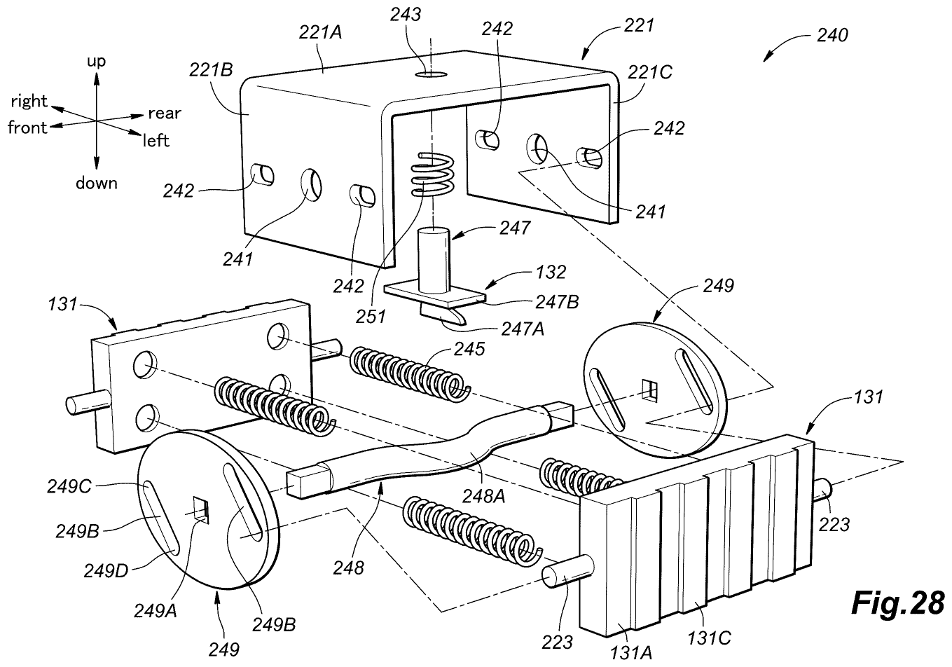

As shown in FIGS. 28 to 30, a slide lock device 240 according to the twelfth embodiment differs from the slide lock device 220 according to the eleventh embodiment with respect to the casing 101, the lock members 131, and the operating member 132. Each of the front wall 221B and the rear wall 221C of the casing 221 is formed with a support hole 241 and left and right guide slots 242. The support hole 241 and the left and right guide slots 242 penetrate the front wall 221B or the rear wall 221C in the front-rear direction. The left and right guide slots 242 are disposed to be spaced from each other and extend laterally. Preferably, the left and right guide slots 242 are disposed on a straight line extending laterally. The support hole 241 is disposed between the left and right guide slots 242. The support hole 241 has a circular cross section. The upper wall 221A is formed with an insertion hole 243 penetrating in the up-down direction.

Each of the front end and the rear end of the main body 131A of each of the left and right lock members 131 is provided with a first guide pin 223 protruding in the front-rear direction. The front and rear first guide pins 223 are received in the corresponding guide slots 242. Thereby, the left and right lock members 131 are supported by the casing 101 to be slidingly movable left and right between the lock position and the release position. Between the left and right lock members 131, multiple urging members 245 for urging the left and right lock members 131 toward the lock position are provided.

The operating member 132 includes an operating shaft 247, a cam shaft 248, a pair of front and rear cam plates 249, and an urging member 251. The operating shaft 247 extends in the up-down direction and is inserted in the insertion hole 243 to be movable in the up-down direction. A pressing part 247A is provided at the lower end of the operating shaft 247. The pressing part 247A has a larger width in the left-right direction than the upper portion of the operating shaft 247. In an intermediate portion of the operating shaft 247 in the up-down direction, a stopper 247B projecting in the radial direction is provided. The stopper 247B is disposed below the upper wall 221A. The stopper 247B cannot pass through the insertion hole 243. The urging member 251 is preferably provided between the stopper 247B and the upper wall 221A. The urging member 251 urges the operating member 132 toward the initial position. The urging member 251 is preferably a tension coil spring. The upper end of the operating shaft 247 is in contact with the rear end of one of the lever side portions 41B of the operation lever 41.

The cam shaft 248 extends in the front-rear direction. The front end and the rear end of the cam shaft 248 are rotatably supported in the front and rear support holes 241. An intermediate portion of the cam shaft 248 is provided with a curved part 248A that protrudes in the radial direction.

The front and rear cam plates 249 are respectively joined to the front end and the rear end of the cam shaft 248. each cam plate 249 rotates integrally with the cam shaft 248. The front cam plate 249 may be disposed in front of or behind the front wall 221B. The rear cam plate 249 may be disposed in front of or behind the rear wall 221C.

Each cam plate 249 is a plate-shaped member having surfaces facing forward and rearward. The cam plate 249 is preferably formed in a circular shape. At the center of the cam plate 249, a joint hole 249A penetrating in the front-rear direction is formed. In the joint hole 249A, the front end or the rear end of the cam shaft 248 is inserted to be joined in a nonrotatable manner.

A pair of cam slots 249B is formed around the joint hole 249A of the cam plate 249. The pair of cam slots 249B is formed to be rotationally symmetrical about the axis of the cam plate 249. Each cam slot 249B penetrates the cam plate 249 in the front-rear direction. The cam slot 249B extends in the circumferential direction of the cam plate 249 and has a first end 249C and a second end 249D. The distance between the first end 249C and the center of the cam plate 249 is greater than the distance between the second end 249D and the center of the cam plate 249. Preferably, the cam slot 249B extends linearly from the first end 249C to the second end 249D.

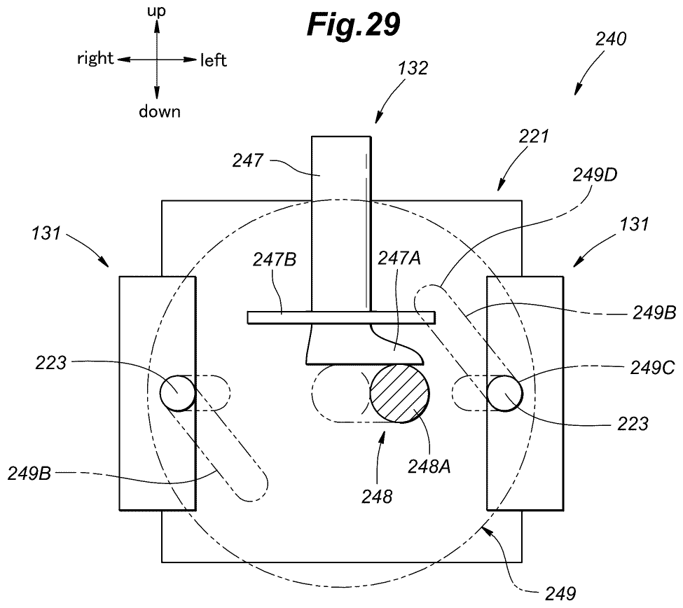

In each cam slot 249B, the first guide pin 223 of the corresponding lock member 131 is inserted. As shown in FIG. 29, when the left and right lock members 131 are in the lock position, each first guide pin 223 is positioned in the first position of the corresponding cam slot 249B. At this time, the curved part 248A of the cam shaft 248 is positioned on the lateral side of the rotation axis of the cam shaft 248.

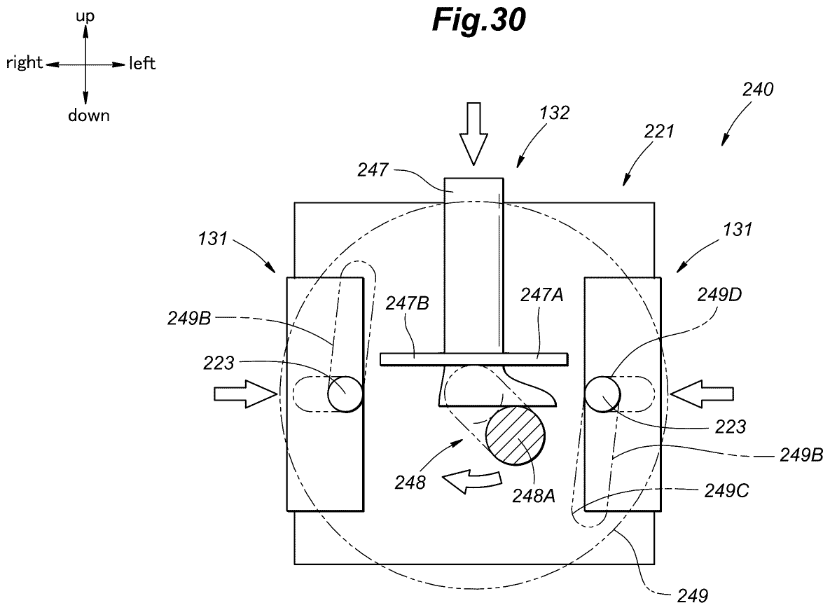

When the user operates the operation lever 41, as shown in FIG. 30, the operating shaft 247 is pushed downward by the operation lever 41, and the operating shaft 247 moves downward. Consequently, the pressing part 247A at the lower end of the operating shaft 247 pushes the curved part 248A of the cam shaft 248 downward. As a result, the cam shaft 248 and the front and rear cam plates 249 rotate. At this time, each first guide pin 223 of the left and right lock members 131 moves in the corresponding cam slot 249B from the first end 249C to the second end 249D. Thereby, the left and right lock members 131 move in directions toward each other in the left-right direction. Namely, the left and right lock members 131 move from the lock position to the release position.

### Thirteenth Embodiment

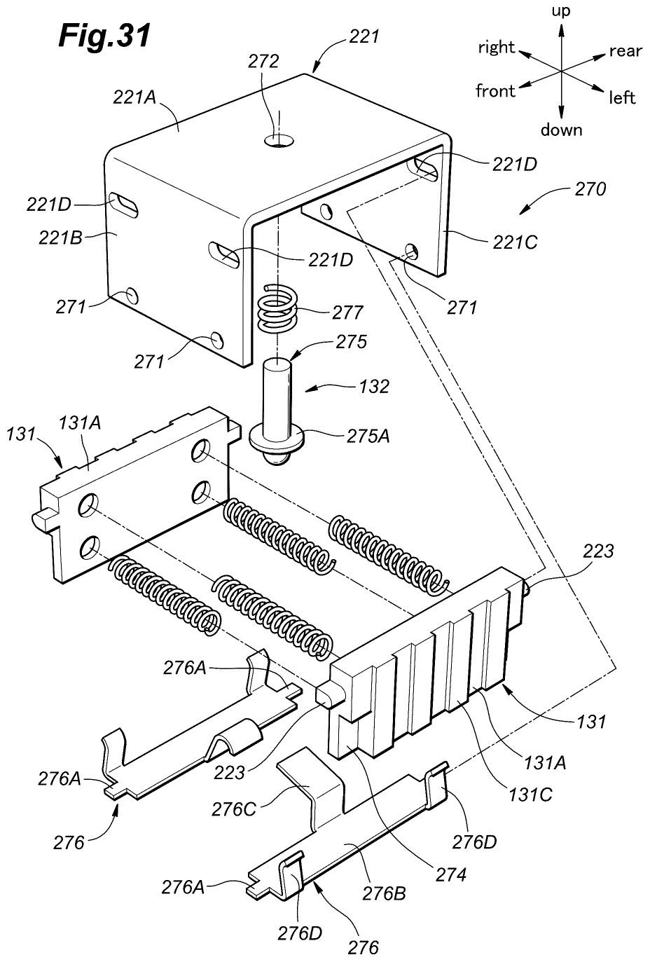

As shown in FIGS. 31 to 33, a slide lock device 270 according to the thirteenth embodiment differs from the slide lock device 220 according to the eleventh embodiment with respect to the casing 221, the lock members 131, and the operating member 132. Each of the front wall 221B and the rear wall 221C is formed with left and right support holes 271 in addition to the guide slot 221D. The upper wall 221A is formed with an insertion hole 272 penetrating in the up-down direction.

Each of the front end and the rear end of the main body 131A of each of the left and right lock members 131 is provided with a first guide pin 223 protruding in the front-rear direction. The front and rear first guide pins 223 are received in the corresponding guide slots 221D. Thereby, the left and right lock members 131 are supported by the casing 101 to be slidingly movable left and right between the lock position and the release position. Between the left and right lock members 131, multiple urging members 245 for urging the left and right lock members 131 toward the lock position are provided. A lower portion of the outer side surface of each main body 131A is formed with locking recesses 274 that are recessed laterally inward.

The operating member 132 includes an operating shaft 275, a pair of left and right levers 276, and an urging member 277. The operating shaft 275 extends in the up-down direction and is inserted in the insertion hole 272 to be movable in the up-down direction. In an intermediate portion of the operating shaft 275 in the up-down direction, a stopper 275A projecting in the radial direction is provided. The stopper 275A is disposed below the upper wall 221A. The stopper 275A cannot pass through the insertion hole 272. The urging member 277 is preferably provided between the stopper 275A and the upper wall 221A. The urging member 277 urges the operating member 132 toward the initial position. The urging member 277 is preferably a tension coil spring. The upper end of the operating shaft 275 is in contact with the rear end of one of the lever side portions 41B of the operation lever 41.

The left and right levers 276 connect the operating member 132 to the left and right lock members 131 and move the left and right lock members 131 according to the movement of the operating member 132. The left and right levers 276 extend in the front-rear direction. Each of the front end and the rear end of each lever 276 is provided with a convex part 276A extending in the front-rear direction. Each convex part 276A may be formed in a cylindrical shape. Each convex part 276A is rotatably inserted in the corresponding support hole 271. Thereby, each lever 276 is supported by the casing 101 to be rotatable about an axis extending in the front-rear direction.

Each lever 276 includes a base portion 276B extending laterally as seen from the front, a first piece 276C protruding upward from one end of the base portion 276B, and second pieces 276D protruding upward from the other end of the base portion 276B, and is formed in a groove shape opened upward. The first piece 276C of the left lever 276 contacts the lower end of the operating shaft 275 from below, and the second pieces 276D of the left lever 276 contact the locking recesses 274 of the left lock member 131 from left. The first piece 276C of the right lever 276 contacts the first piece 276C of the left lever 276 from below, and the second pieces 276D of the right lever 276 contact the locking recesses 274 of the right lock member 131 from right.

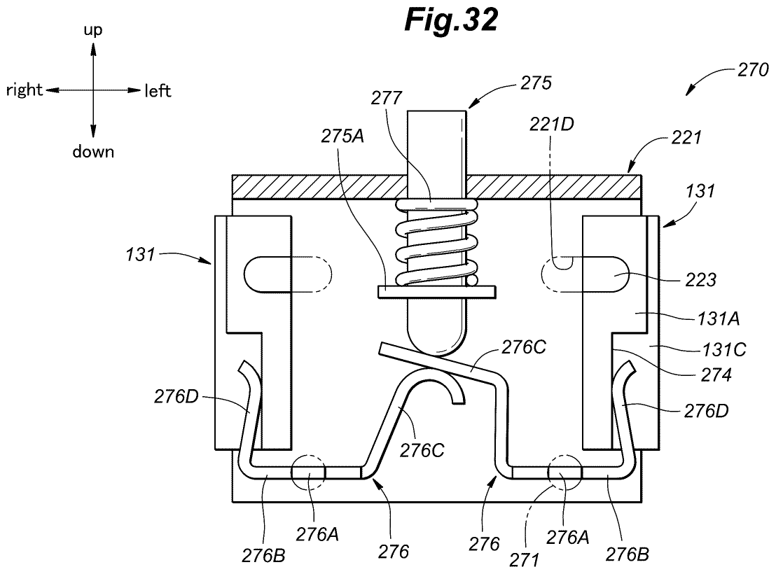

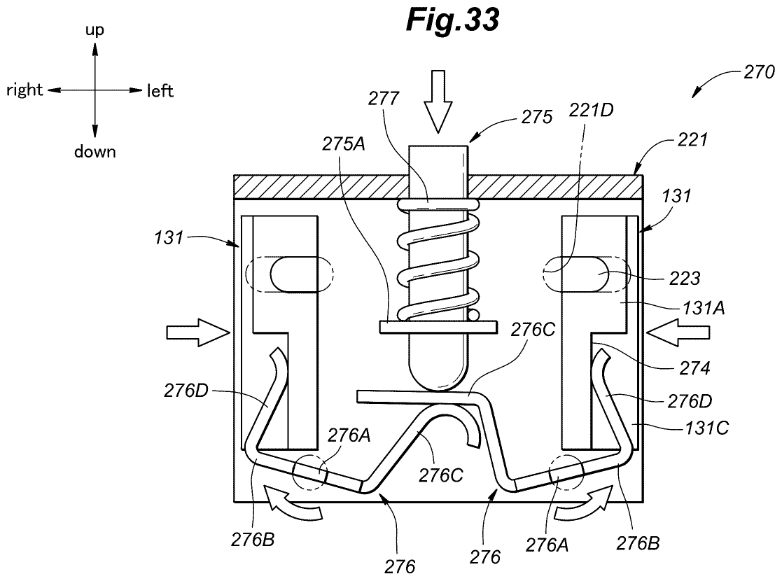

As shown in FIG. 32, when the operating member 132 is in the initial position, the left and right lock members 131 are positioned in the lock position. When the user operates the operation lever 41, as shown in FIG. 33, the operating shaft 275 is pushed downward by the operation lever 41, and the operating shaft 275 moves downward. Consequently, the left and right levers 276 pivot and push the left and right lock members 131 laterally inward. Namely, the left and right levers 276 move the left and right lock members 131 from the lock position to the release position.

### Fourteenth Embodiment

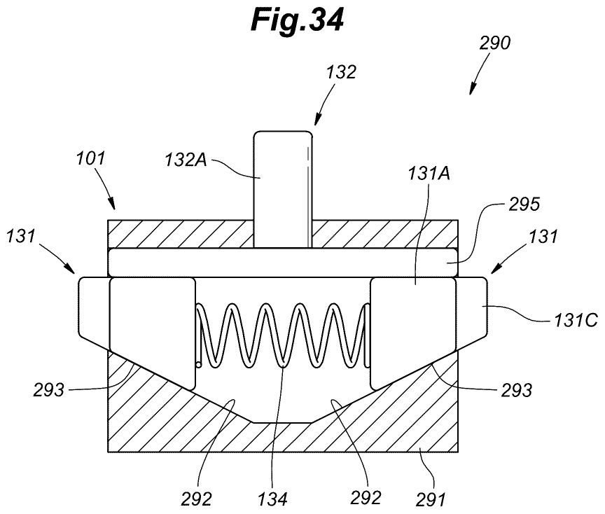

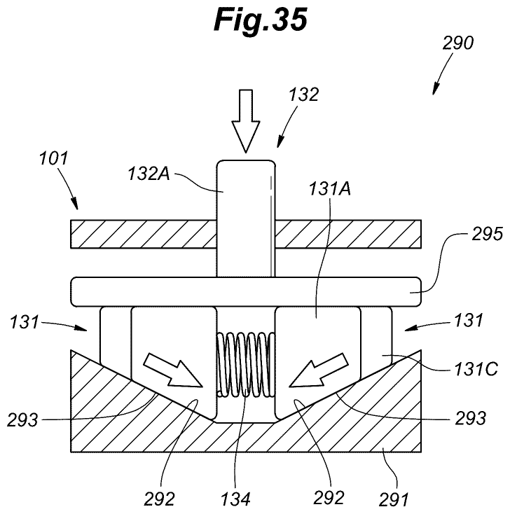

As shown in FIGS. 34 to 35, a slide lock device 290 according to the fourteenth embodiment differs from the slide lock device 130 according to the third embodiment with respect to the casing 101, the lock members 131, and the operating member 132. An upper surface of a bottom wall 291 of the casing 101 is provided with inclined surfaces 292 inclined downward toward laterally inside.

The lower surface of the main body 131A of each of the left and right lock members 131 is provided with an inclined surface 293 that is inclined downward toward laterally inside. The left and right lock members 131 are urged by the urging member 134 toward the lock position.

The operating member 132 includes an operating shaft 132A extending in the up-down direction and a pressing part 295 provided at the lower end of the operating shaft 132A. The pressing part 295 is preferably formed in a plate shape.

As shown in FIG. 34, when the left and right lock members 131 are in the lock position, the operating member 132 is pushed upward by the lock members 131 to be in the initial position.

When the user operates the operation lever 41, the operating shaft 132A is pushed downward by the operation lever 41, and the operating shaft 132A moves downward. Consequently, the left and right lock members 131 are pushed by the pressing part 295, and move downward relative to the casing 101. At this time, the left and right lock members 131 are guided by the inclined surfaces 292 and move laterally inward. Namely, the left and right lock members 131 move to the release position.

### Fifteenth Embodiment

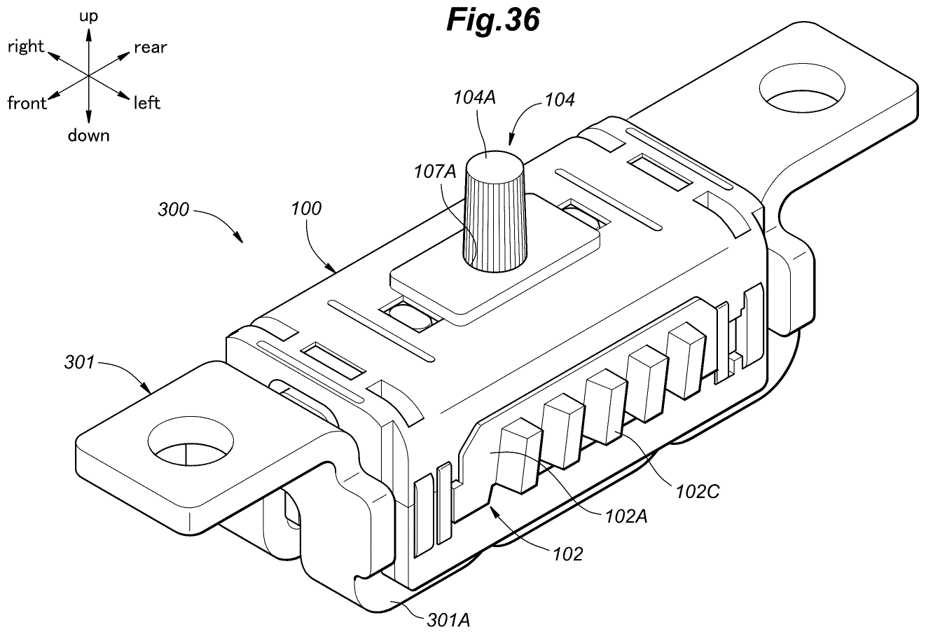

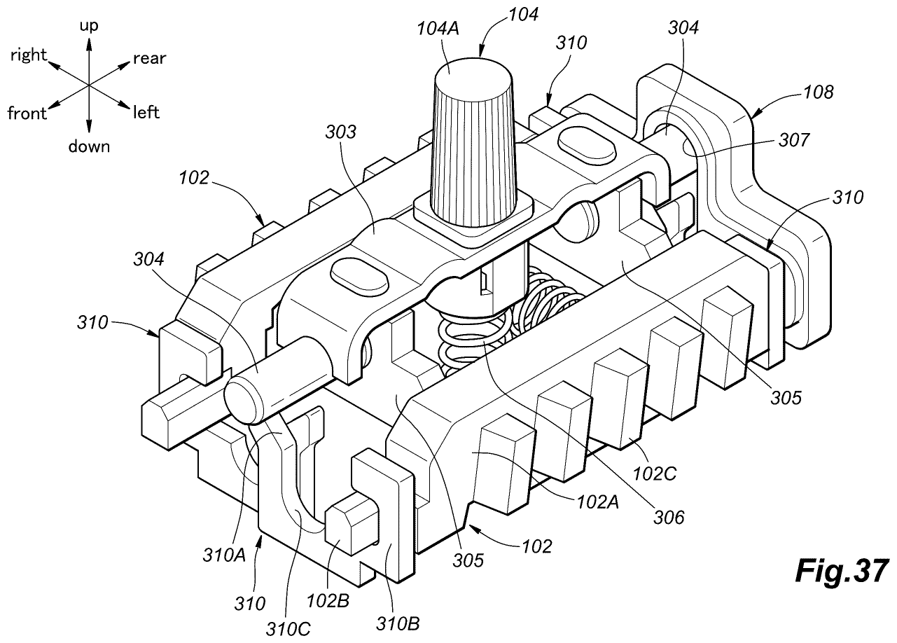

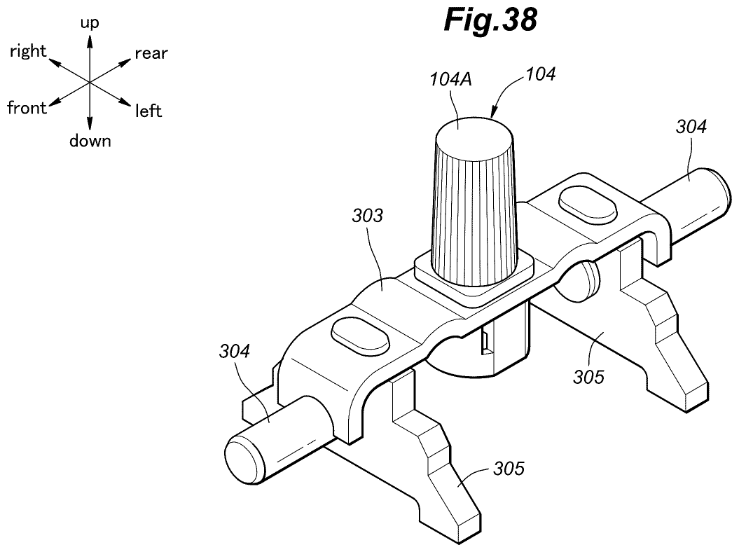

As shown in FIGS. 36 to 40, a slide lock device 300 according to the fifteenth embodiment differs from the slide lock device 100 according to the second embodiment with respect to the configurations of the lock members 102, the operating member 104, the guide members 108, etc. The same configurations are denoted by the same reference signs and the description thereof will be omitted.

As shown in FIG. 36, the casing 101 is configured to be fastened to the lower surface of the slider upper wall 12A by a bracket 301. The bracket 301 extends in the front-rear direction and is fastened to the slider upper wall 12A at the front end and the rear end. A central part 301A of the bracket 301 in the front-rear direction is recessed downward. The casing 101 is fixed to the upper surface of the central part.

The operating member 104 includes an operating shaft 104A and a connecting member 303 extending forward and rearward from the lower end of the operating shaft 104A. At each of the front end and rear end of the connecting member 303, a pressing shaft 304 extending in the front-rear direction is provided. A pair of front and rear stoppers 305 are provided on a lower side of the front portion and the rear portion of the connecting member 303. Each stopper 305 extends downward from the connecting member 303 and extends to both the left and right sides. The operating member 104 is urged by an urging member 306 upward, namely, toward the initial position.

The front and rear guide members 108 are formed with second guide holes 307 for receiving the front and rear pressing shafts 304. Each second guide hole 307 extends in the up-down direction. Each pressing shaft 304 can move in the up-down direction in the corresponding second guide hole 307.

Between the front end of the connecting member 303 and the front guide member 108, left and right cam members 310 are provided. Between the rear end of the connecting member 303 and the rear guide member 108 also, similar left and right cam members 310 are provided. The left cam member 310 moves the left lock member 102 rightward, namely, toward the release position, when the pressing shaft 304 moves downward. The right cam member 310 moves the right lock member 102 leftward, namely, toward the release position, when the pressing shaft 304 moves downward. The left and right cam members 310 are supported by the casing 101 to be slidingly movable in the left-right direction.

The left cam member 310 includes a cam surface 310A disposed below the pressing shaft 304 and a locking part 310B for locking the guide shaft 102B of the left lock member 102. The cam surface 310A is inclined downward toward the left. The locking part 310B may be a hook locking the guide shaft 102B or a hole into which the guide shaft 102B protrudes. The right cam member 310 is formed to be bilaterally symmetrical with the left cam member 310. As seen from the front, the left and right cam members 310 have an overlap. As seen from the front, the left and right cam surfaces 310A intersect with each other.

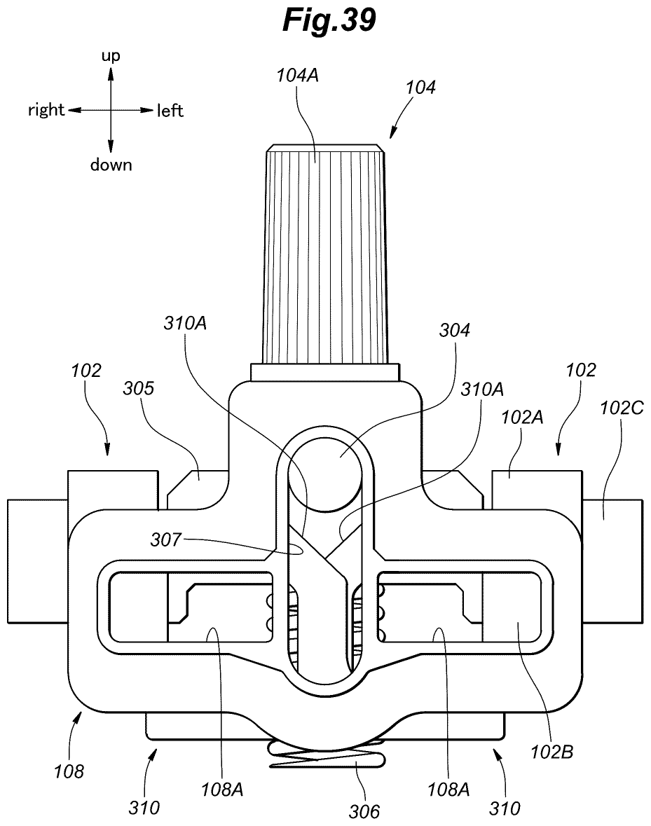

As shown in FIG. 39, when the operating member 104 is in the initial position, the pressing shaft 304 is separated upward from the cam surface 310A of each cam member 310. At this time, the left and right lock members 102 are positioned in the lock position due to the urging members 103. Also, each stopper 305 of the operating member 104 contacts the inner side surface of the main body 102A of the corresponding lock member 102 and each lock member 102 is maintained in the lock position.

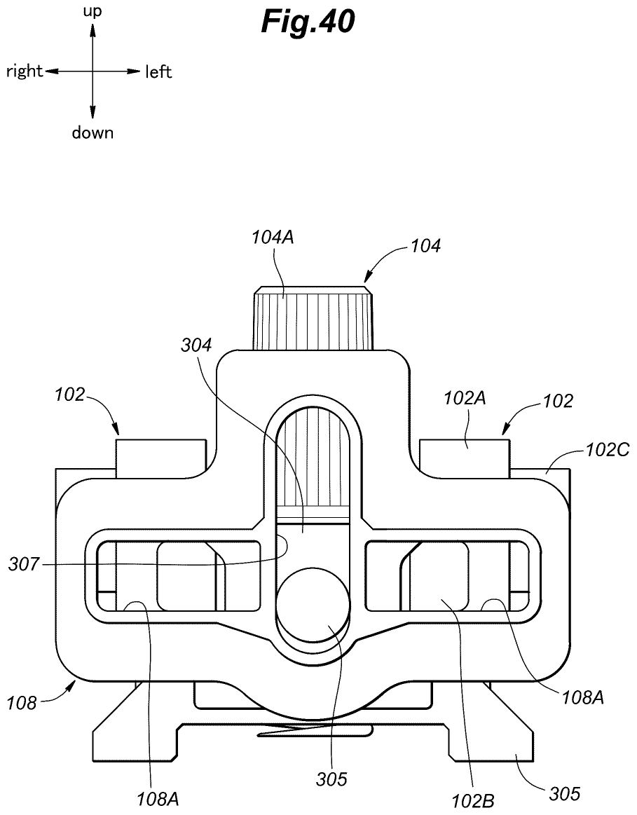

When the user pulls the lever central part 41A of the operation lever 41 upward, the rear end of each of the left and right lever side portions 41B pushes the upper end of the operating shaft 104A. Thereby, as shown in FIG. 40, the operating member 104 slidingly moves downward and moves from the initial position to the post-operation position. At this time, each stopper 305 of the operating member 104 is separated from each main body 102A, and each lock member 102 becomes movable from the lock position to the release position.

When the operating member 104 is moved further downward toward the post-operation position, each pressing shaft 304 pushes the corresponding cam surfaces 310A downward. Thereby, the left and right cam members 310 move laterally inward, and the lock members 102 move from the lock position to the release position. Consequently, the multiple convex parts 102D are separated from the locking holes 15 of the rail 11 and move to the inside of the casing 101. Thereby, the slider 12 becomes movable relative to the rail 11.

When the lock members 102 reach the release position, the pressing shafts 304 are separated from the end portions of the cam surfaces 310A. Therefore, the lock members 102 are prevented from receiving a load after reaching the release position. Also, each cam member 310 is provided, adjacent to the cam surface 310A, with a recessed part 310C that is recessed downward. Due to the recessed part 310C, even if the pressing shaft 304 is moved further downward, contact between the pressing shaft 304 and the cam member 310 in the up-down direction can be avoided.

### Sixteenth Embodiment

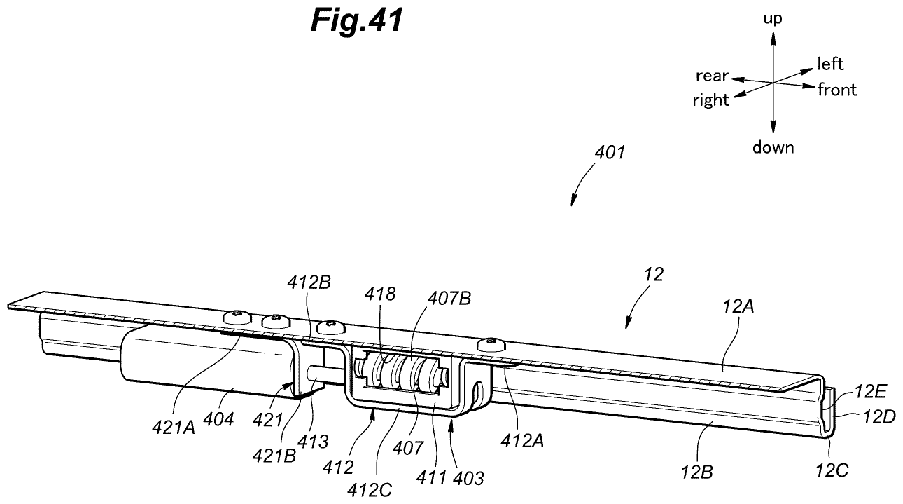

With reference to FIGS. 41 to 43, an electric slide rail 401 according to the sixteenth embodiment will be described. The electric slide rail 401 includes a rail 11 and a slider 12 slidingly movable relative to the rail 11. With the slider 12 moving relative to the rail 11, the electric slide rail 401 moves the vehicle seat 3 relative to the floor 2. The configurations of the vehicle seat 3, the rail 11, and the slider 12 are the same as in the first embodiment, and the description thereof will be omitted.

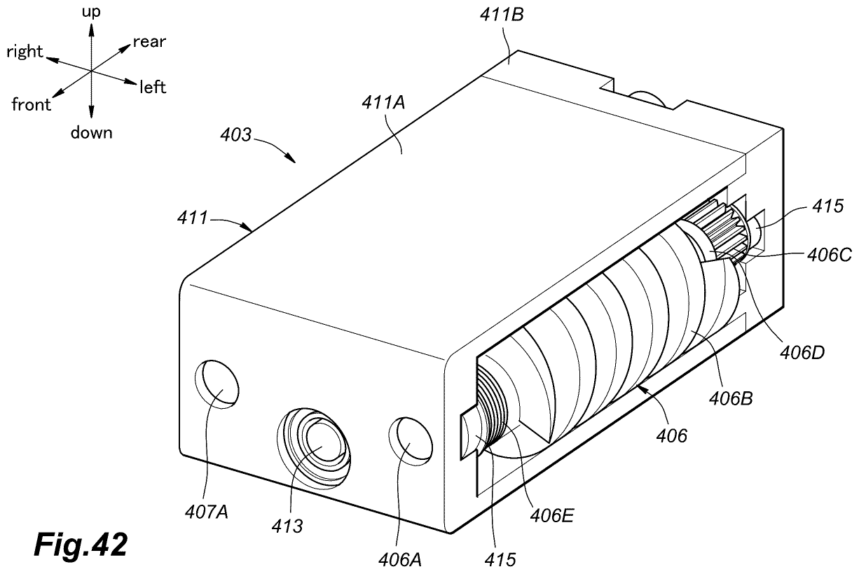

As shown in FIG. 41, the electric slide rail 401 includes a rail 11 extending in the front-rear direction and a slider 12 slidably engaged with the rail 11. As shown in FIGS. 41 and 42, a screw assembly 403 and an electric motor 404 are supported on the lower surface of the slider upper wall 12A. The screw assembly 403 includes screw members 406, 407 supported by the slider 12 to be rotatable about an axis extending in the front-rear direction. The electric motor 404 is supported by the slider 12 and rotates the screw members 406, 407.

In the present embodiment, the screw members 406, 407 include a first screw member 406 and a second screw member 407. In another embodiment, the screw assembly 403 may include a single screw member.

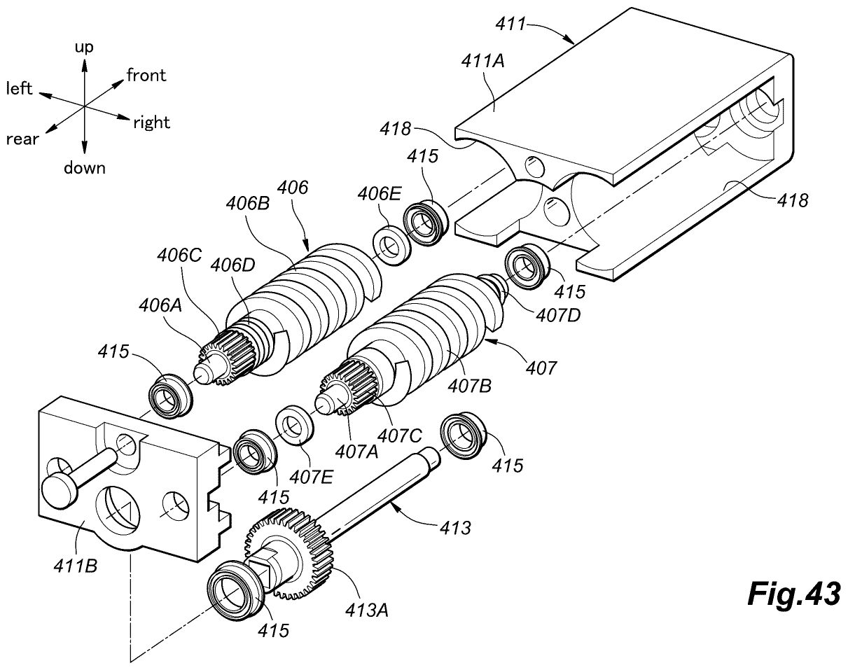

As shown in FIG. 43, the first screw member 406 has a shaft part 406A extending in the front-rear direction and a screw thread 406B formed on an outer circumferential surface of an intermediate portion of the shaft part 406A in the longitudinal direction. Similarly, the second screw member 407 has a shaft part 407A extending in the front-rear direction and a screw thread 407B formed on an outer circumferential surface of an intermediate portion of the shaft part 407A in the longitudinal direction. The number of the screw threads 406B, 407B is preferably decided depending on the size of the electric slide rail 401 and the required strength of the electric slide rail 401 in the longitudinal direction. For example, when it is desired to increase the required strength, it is preferred to increase the number of the screw threads 406B, 407B. As shown in FIG. 41, the screw assembly 403 includes a gear case 411 rotatably supporting the first screw member 406 and the second screw member 407 and a first bracket 412 supporting the gear case 411 on the slider 12.

As shown in FIGS. 42 and 43, the gear case 411 is formed in a rectangular box shape elongated in the front-rear direction. The gear case 411 rotatably supports the first screw member 406, the second screw member 407, and a drive shaft 413 coupled to the rotation shaft of the electric motor 404. The first screw member 406, the second screw member 407, and the drive shaft 413 each extend in the front-rear direction and are disposed in the gear case 411 to be in parallel with each other. The gear case 411 includes a case main body 411A in a box shape that is opened rearward and a lid 411B joined to the rear end of the case main body 411A. The case main body 411A and the lid 411B are fastened to each other with screws.

The front end and the rear end of the shaft part 406A of the first screw member 406, the front end and the rear end of the shaft part 407A of the second screw member 407, and the front end and the rear end of the drive shaft 413 are each supported by the gear case 411 to be rotatable and movable in the front-rear direction. Preferably, the front end and the rear end of the shaft part 406A of the first screw member 406, the front end and the rear end of the shaft part 407A of the second screw member 407, and the front end and the rear end of the drive shaft 413 are each supported by the gear case 411 via a bearing 415.

The first screw member 406 is disposed along the left side part of the gear case 411, and the second screw member 407 is disposed along the right side part of the gear case 411. The drive shaft 413 is disposed below the middle between the first screw member 406 and the second screw member 407.

The drive shaft 413 includes a drive gear 413A inside the gear case 411. The first screw member 406 has a first gear 406C engaged with the drive gear 413A. The second screw member 407 has a second gear 407C engaged with the drive gear 413A. Each of the drive gear 413A, the first gear 406C, and the second gear 407C may be a spur gear. When the drive shaft 413 rotates, the first screw member 406 and the second screw member 407 rotate in the same direction as each other. The first gear 406C and the second gear 407C may be symmetrical in shape.

The first gear 406C is supported to be displaceable in the front-rear direction (the axial direction) relative to the shaft part 406A of the first screw member 406 and nonrotatable relative to the shaft part 406A. For example, preferably, a polygonal hole is formed at the center of the first gear 406C, and the shaft part 406A has a polygonal columnar part fitted in the polygonal hole to be nonrotatable and movable in the front-rear direction. Similarly, the second gear 407C is supported to be displaceable in the front-rear direction (the axial direction) relative to the shaft part 407A of the second screw member 407 and nonrotatable relative to the shaft part 407A. The first gear 406C and the second gear 407C have a length in the front-rear direction. Therefore, even when the first gear 406C moves in the front-rear direction, the engagement between the first gear 406C and the drive gear 413A is maintained. Similarly, even when the second gear 407C moves in the front-rear direction, the engagement between the second gear 407C and the drive gear 413A is maintained.

The screw assembly 403 includes a first urging member 406D for urging the first screw member 406 in the front-rear direction. In the present embodiment, the first urging member 406D is supported on the rear end of the shaft part 406A. The first urging member 406D is disposed between the screw thread 406B and the first gear 406C. The first urging member 406D urges the shaft part 406A and the screw thread 406B forward relative to the gear case 411.

The screw assembly 403 includes a second urging member 407D for urging the second screw member 407 in the front-rear direction. In the present embodiment, the second urging member 407D is supported on the front end of the shaft part 407A. The second urging member 407D is disposed between the screw thread 406B and the front bearing 415. The second urging member 407D urges the shaft part 407A and the screw thread 407B rearward relative to the gear case 411. The first urging member 406D and the second urging member 407D may be at least one disc spring, compression coil spring, leaf spring, rubber, etc.

A first cushioning member 406E may be provided in the gap between the first screw member 406 and the gear case 411 in the front-rear direction. The first cushioning member 406E is preferably provided on the end portion of the shaft part 406A opposite from the first urging member 406D. In the present embodiment, the first cushioning member 406E is supported on the front end of the shaft part 406A. The first cushioning member 406E is disposed between the screw thread 406B and the front bearing 415.

A second cushioning member 407E may be provided in the gap between the second screw member 407 and the gear case 411 in the front-rear direction. The second cushioning member 407E is preferably provided on the end portion of the shaft part 407A opposite from the second urging member 407D. In the present embodiment, the second cushioning member 407E is supported on the rear end of the shaft part 407A. The second cushioning member 407E is disposed between the screw thread 407B and the rear bearing 415. The first cushioning member 406E and the second cushioning member 407E may be rubber, nonwoven fabric, or the like.

As shown in FIGS. 41 and 42, the gear case 411 has case openings 418 which are openings for exposing the first screw member 406 and the second screw member 407 to the side. The screw thread 406B of the first screw member 406 passes through the case opening 418 formed in the left side part of the gear case 411 and protrudes leftward. Similarly, the screw thread 407B of the second screw member 407 passes through the case opening 418 formed in the right side part of the gear case 411 and protrudes rightward. The case openings 418 are formed in the case main body 411A.

The first bracket 412 extends in the front-rear direction and includes a first joint part 412A provided at the front end and a second joint part 412B provided at the rear end. The first bracket 412 is joined to the lower surface of the slider upper wall 12A of the slider 12 at the first joint part 412A and the second joint part 412B. The first bracket 412 includes a support part 412C extending from the first joint part 412A to the second joint part 412B. The first bracket 412 is preferably an integral metal member including the first joint part 412A, the second joint part 412B, and the support part 412C. The support part 412C has portions positioned below the first joint part 412A and the second joint part 412B. Due to the support part 412C, the first bracket 412 forms a closed structure in cooperation with the slider upper wall 12A. The gear case 411 is disposed between the slider upper wall 12A of the slider 12 and the support part 412C.

The first bracket 412 is formed by bend-forming a metal sheet. The first joint part 412A extends out forward from the front portion of the gear case 411, and the second joint part 412B extends out rearward from the rear portion of the gear case 411. The first joint part 412A and the second joint part 412B are preferably fastened to the slider upper wall 12A by fastening members, such as screws, rivets, or the like. The distance between the fastening points of the first joint part 412A and the second joint part 412B is set to be longer than the front-rear length of the gear case 411.

Behind the first bracket 412, a second bracket 421 for supporting the electric motor 404 on the slider upper wall 12A of the slider 12 is provided. The second bracket 421 includes a joint part 421A joined to the slider upper wall 12A and a support part 421B extending from the joint part 421A in a direction opposite from the slider upper wall 12A, namely, downward. The support part 421B is perpendicular to the joint part 421A, whereby the second bracket 421 is formed in an L shape. The electric motor 404 is joined to the support part 421B at one end portion thereof. In the present embodiment, the electric motor 404 is disposed below the joint part 421A, and the second bracket 421 supports the end portion of the electric motor 404 on the side of the screw members 406, 407 in a cantilever manner.

The rear end of the drive shaft 413 protrudes rearward from a rear support member 411C of the gear case 411 and extends rearward to pass through the through hole formed in the first bracket 412. The rotation shaft of the electric motor 404 is connected to the rear end portion of the drive shaft 413. The rotation shaft of the electric motor 404 and the drive shaft 413 are preferably joined to each other by a coupling. Also, the rotation shaft of the electric motor 404 and the drive shaft 413 may have fitting parts that are engaged with each other. The rotation shaft of the electric motor 404 and the drive shaft 413 are arranged on the same straight line. The electric motor 404 is formed in a cylindrical shape and extends in the front-rear direction.

A speed reducer may be provided between the rotation shaft of the electric motor 404 and the drive shaft 413. The speed reducer is preferably a planetary gear mechanism, for example. The speed reducer is preferably provided on the surface of the support part 421B of the second bracket 421 opposite from the electric motor 404. In another embodiment, the speed reducer may be supported on the rear end surface of the gear case 411. The speed reducer is an optional configuration and may be omitted.

The rotation shaft of the electric motor 404 and the drive shaft 413 may be coupled via a flexible shaft. Thereby, the rotation shaft of the electric motor 404 and the drive shaft 413 can be arranged to be offset from each other. In this way, the degree of freedom of the layout of the screw assembly 403 and the electric motor 404 is improved.

The screw assembly 403, the electric motor 404, the first bracket 412, and the second bracket 421 are disposed below the slider upper wall 12A and between the left and right slider inner side walls 12B. The left and right slider inner side walls 12B each have a slider opening 12F at a position corresponding to the screw assembly 403. The slider opening 12F is formed in the recessed part 12E of the slider inner side wall 12B. The left part of the screw thread 406B of the first screw member 406 passes through the left case opening 418 of the gear case 411 and the slider opening 12F of the left slider inner side wall 12B and protrudes leftward of the left slider inner side wall 12B. Similarly, the right part of the screw thread 407B of the second screw member 407 passes through the right case opening 418 of the gear case 411 and the slider opening 12F of the right slider inner side wall 12B and protrudes rightward of the right slider inner side wall 12B.

The rail 11 is formed with locking holes 15 extending in the front-rear direction to be engaged with the screw members 406, 407. The first screw member 406 is engaged with the multiple locking holes 15 at the left part of the screw thread 406B and moves forward and rearward relative to the locking holes 15 by rotating. Similarly, the second screw member 407 is engaged with the multiple locking holes 15 at the right part of the screw thread 407B and moves forward and rearward relative to the locking holes 15 by rotating.

The rotation of the electric motor 404 is transmitted to the first screw member 406 and the second screw member 407 via the rotation shaft, the drive shaft 413, the drive gear 413A, and the first gear 406C or the second gear 407C. As a result, the first screw member 406 and the second screw member 407 rotate in the same direction. When the first screw member 406 and the second screw member 407 rotate, the first screw member 406 and the second screw member 407 move forward or rearward relative to the locking holes 15, and the slider 12 moves forward or rearward relative to the rail 11.

In the electric slide rail 401 according to the present embodiment, since the electric motor 404 and the screw assembly 403 are fixed to the slider 12, tilting of the first screw member 406 and the second screw member 407 relative to the locking holes 15 is suppressed. Therefore, the first screw member 406 can be engaged with the locking holes 15 at an appropriate angle, and the rotation of the first screw member 406 becomes smooth. The same applies to the second screw member 407. As a result, the electric slide rail 401 capable of operating smoothly can be provided. Also, since the electric motor 404 is mounted to the slider 12 received in the rail 11, the external shape of the electric slide rail 401 can be made compact. Further, since the electric motor 404 is disposed inside the slider 12, the distance between the electric motor 404 and the screw assembly 403 can be reduced, and the length of the drive shaft 413 connecting the electric motor 404 to the screw assembly 403 can be shortened. Thus, deflection of the drive shaft 413 is suppressed, and the screw assembly 403 can rotate smoothly.

Because the screw assembly 403 includes two screw members, namely, the first screw member 406 and the second screw member 407, the screw assembly 403 can be made compact while being engaged with the locking holes 15 of both of the rail inner side walls. Also, since the direction of the reaction force that the first screw member 406 receives from the locking holes 15 and the direction of the reaction force that the second screw member 407 receives from the locking holes 15 are opposite from each other, the first screw member 406 is reliably engaged with the locking holes 15, and the second screw member 407 is reliably engaged with the locking holes 15.

The first screw member 406 and the second screw member 407 constitute the screw assembly 403 together with the gear case 411 and the first bracket 412, and thus, the assembly to the slider 12 is easy.

Since the first urging member 406D urges the screw thread 406B forward, the screw thread 406B can contact the front edges of the locking holes 15 when the electric motor 404 is stopped. Also, since the second urging member 407D urges the screw thread 407B rearward, the screw thread 407B can contact the rear edges of the locking holes 15 when the electric motor 404 is stopped. Due to these, rattling of the screw assembly 403 relative to the rail 11 can be suppressed.

Due to the first cushioning member 406E, collision between the first screw member 406 and the bearing 415 in the front-rear direction is suppressed and generation of collision sound is suppressed. Due to the second cushioning member 407E, collision between the second screw member 407 and the bearing 415 in the front-rear direction is suppressed and generation of collision sound is suppressed.

### Seventeenth Embodiment

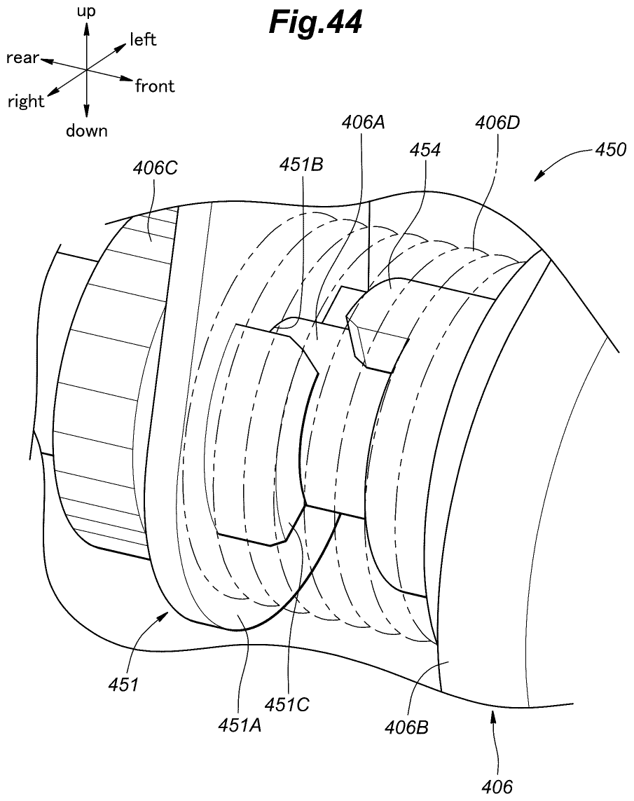

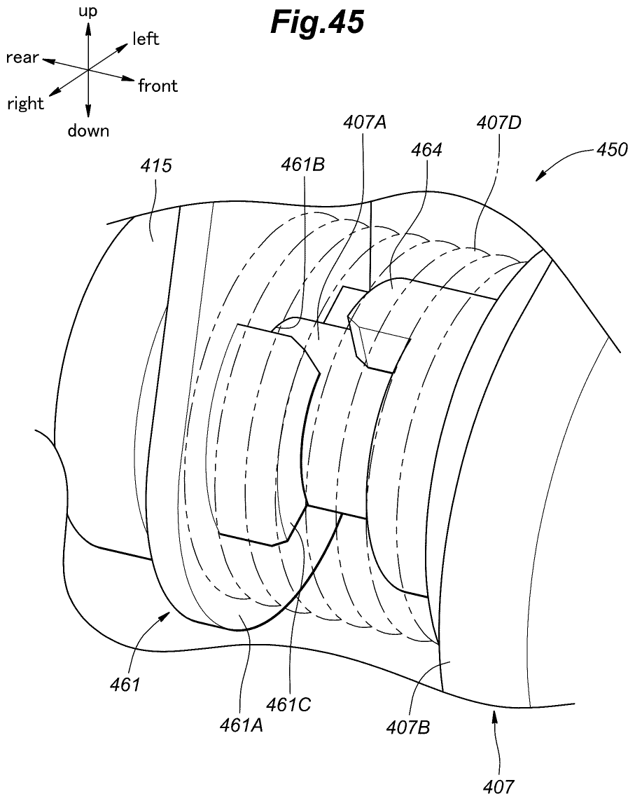

With reference to FIGS. 44 and 45, an electric slide rail 450 according to the seventeenth embodiment will be described. As shown in FIG. 44, in the electric slide rail 450, a first lock plate 451 is provided between the screw thread 406B of the first screw member 406 and the first gear 406C. The first lock plate 451 includes a plate part 451A having surfaces facing forward and rearward and fixed to the gear case 411, an insertion hole 451B penetrating the plate part 451A in the front-rear direction, and at least one convex part 451C protruding from the plate part 451A toward the screw thread 406B. The shaft part 406A of the first screw member 406 passes through the insertion hole 451B.

At the rear end of the screw thread 406B, at least one convex part 454 protruding rearward is provided. The first urging member 406D is provided between the plate part 451A of the first lock plate 451 and the screw thread 406B. The first urging member 406D urges the screw thread 406B forward relative to the first lock plate 451.

As shown in FIG. 45, a second lock plate 461 is provided between the screw thread 407B of the second screw member 407 and the front bearing 415. The second lock plate 461 includes a plate part 461A having surfaces facing forward and rearward and fixed to the gear case 411, an insertion hole 461B penetrating the plate part 461A in the front-rear direction, and at least one convex part 461C protruding from the plate part 461A toward the screw thread 407B. The shaft part 407A of the second screw member 407 passes through the insertion hole 461B.

At the front end of the screw thread 407B, at least one convex part 464 protruding forward is provided. The second urging member 407D is provided between the plate part 461A of the second lock plate 461 and the screw thread 407B. The second urging member 407D urges the screw thread 407B rearward relative to the second lock plate 461.

When a predetermined forward load is not applied to the slider 12, the convex part 451C of the first lock plate 451 and the convex part 454 of the screw thread 406B are separated from each other in the front-rear direction due to the urging force of the first urging member 406D. Therefore, the first screw member 406 can rotate relative to the first lock plate 451 and the gear case 411. Similarly, when a predetermined rearward load is not applied to the slider 12, the convex part 461C of the second lock plate 461 and the convex part 464 of the screw thread 407B are separated from each other in the front-rear direction due to the urging force of the second urging member 407D.

Therefore, the second screw member 407 can rotate relative to the second lock plate 461 and the gear case 411. Note that when the electric motor 404 is rotating also, the first screw member 406 and the second screw member 407 can similarly rotate relative to the gear case 411.

When a predetermined forward load is applied to the slider 12, the gear case 411 and the first lock plate 451 move forward against the urging force of the first urging member 406D, and the convex part 451C of the first lock plate 451 and the convex part 454 of the screw thread 406B engage in the circumferential direction. Thereby, the first screw member 406 becomes nonrotatable relative to the first lock plate 451 and the gear case 411. Similarly, when a predetermined rearward load is applied to the slider 12, the gear case 411 and the second lock plate 461 move rearward against the urging force of the second urging member 407D, and the convex part 461C of the second lock plate 461 and the convex part 464 of the screw thread 407B engage in the circumferential direction. Thereby, the second screw member 407 becomes nonrotatable relative to the second lock plate 461 and the gear case 411. In this way, when a predetermined forward or rearward load is applied to the slider 12, the rotation of the first screw member 406 or the second screw member 407 is restricted, whereby the movement of the slider 12 relative to the rail 11 is restricted.

### Eighteenth Embodiment

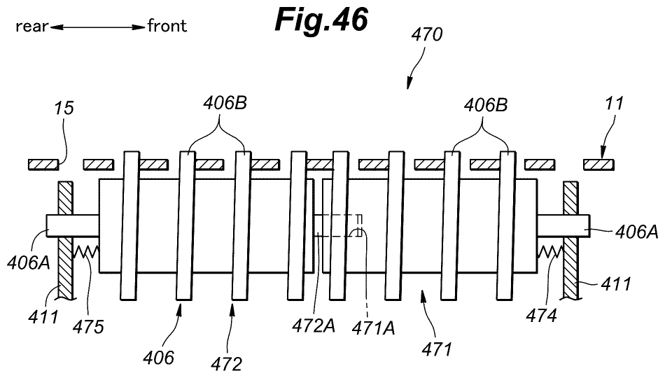

With reference to FIG. 46, an electric slide rail 470 according to the eighteenth embodiment will be described. As shown in FIG. 46, the first screw member 406 may be longitudinally divided into a front portion 471 and a rear portion 472. The front portion 471 and the rear portion 472 are connected to be movable in the front-rear direction relative to each other and nonrotatable relative to each other. For example, the rear end of the front portion 471 is preferably formed with a polygonal hole 471A, and the front end of the rear portion 472 is preferably provided with a polygonal pillar 472A protruding into the polygonal hole 471A to be movable in the front-rear direction and nonrotatable.

The front portion 471 is urged rearward relative to the gear case 411 by a front urging member 474. The rear portion 472 is urged forward relative to the gear case 411 by a rear urging member 475. Consequently, the screw thread 406B of the front portion 471 contacts the rear edges of the locking holes 15 of the rail 11, and the screw thread 406B of the rear portion 472 contacts the front edges of the locking holes 15 of the rail 11. Therefore, rattling of the rail 11 relative to the screw assembly 403 is suppressed. The same applies to the second screw member 407.

The axial length of the first screw member 406 including the front portion 471 and the rear portion 472 is preferably set shorter than the axial length of the electric motor 404. The axial length of the first screw member 406 including the front portion 471 and the rear portion 472 may be set longer than the axial length of the electric motor 404. The same applies to the second screw member 407.

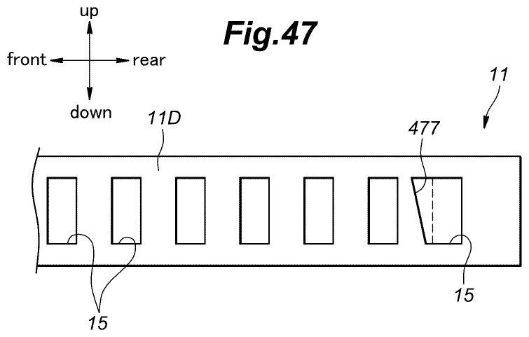

As shown in FIG. 47, the rearmost locking hole 15 of the rail 11 preferably has an extension part 477 which expands the width forward. In the state before the slider 12 having the screw assembly 403 mounted thereto is assembled with the rail 11, the front portion 471 and the rear portion 472 are brought into positions closest to each other state by the front urging member 474 and the rear urging member 475. Thereby, the distance between the rear end of the screw thread 406B of the front portion 471 and the front end of the screw thread 406B of the rear portion 472, namely, the pitch, is short. Thus, if the multiple locking holes 15 were arranged at equal intervals, the front end of the screw thread 406B of the rear portion 472 could not be smoothly inserted into the rearmost locking hole 15 when the slider 12 is inserted into the rail 11 from rear. In the present embodiment, since the rearmost locking hole 15 has the extension part 477, the front end of the screw thread 406B of the rear portion 472 can be smoothly inserted into the rearmost locking hole 15. After the front end of the screw thread 406B of the rear portion 472 is inserted into the rearmost locking hole 15, the rear portion 472 relatively moves away rearward from the front portion 471 against the urging force of the rear urging member 475 in accordance with the interval of the multiple locking holes 15. The same applies to the second screw member 407.

When the slider 12 is inserted into the rail 11 from front, the frontmost locking hole 15 of the rail 11 preferably has an extension part (not shown in the drawings) expanding the width rearward.

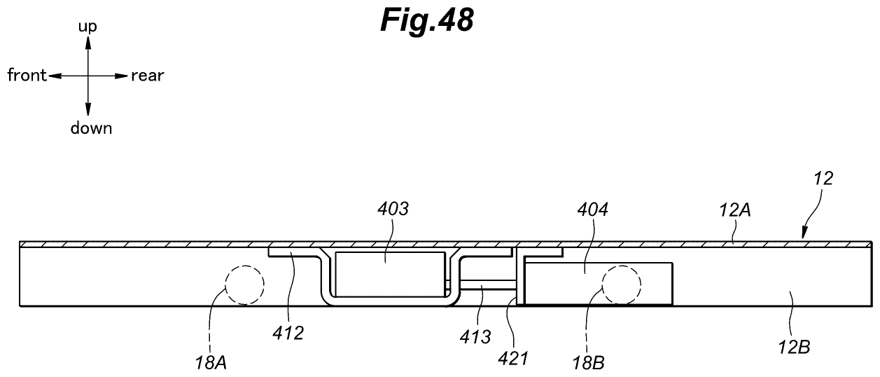

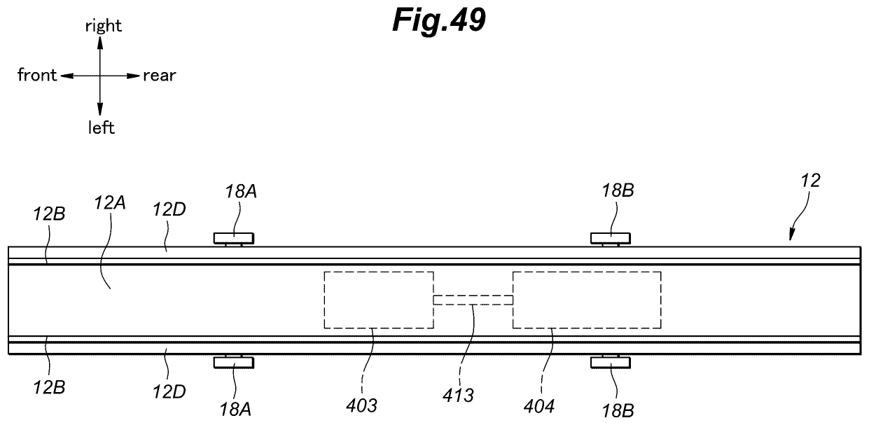

Description will now be made of the positions of the multiple wheels 18 in the slider 12 related to the sixteenth to eighteenth embodiments. As shown in FIGS. 48 and 49, the multiple wheels 18 include left and right front wheels 18A and left and right rear wheels 18B. As seen in the left-right direction, the left and right front wheels 18A are disposed forward of the screw assembly 403. As seen in the left-right direction, the left and right rear wheels 18B are disposed in a position overlapping the electric motor 404.

Since the left and right front wheels 18A are disposed to avoid the screw assembly 403 and the electric motor 404, increase in the left-right width of the slider 12 can be suppressed.

Since the left and right rear wheels 18B are disposed in a position overlapping the electric motor 404 as seen in the left-right direction, increase in the front-rear length of the slider 12 can be suppressed.

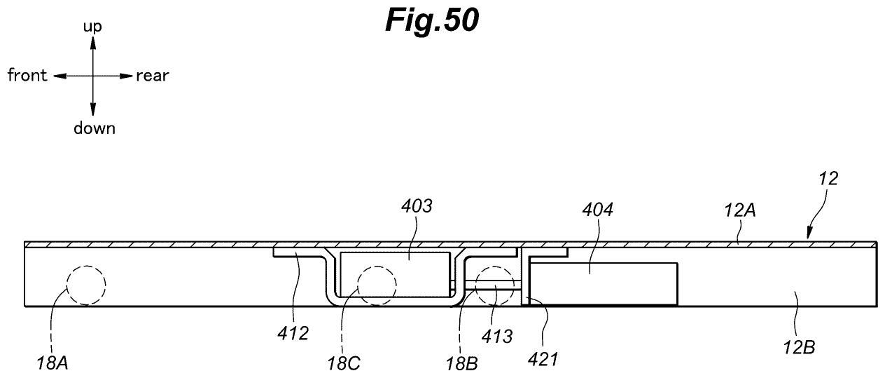

As shown in FIG. 50, in another embodiment, the multiple wheels 18 may include left and right front wheels 18A, left and right rear wheels 18B, and left and right intermediate wheels 18C. The left and right front wheels 18A are preferably disposed at the front end of the slider 12 as seen in the left-right direction. The left and right intermediate wheels 18C may be disposed in a position overlapping the screw assembly 403 as seen in the left-right direction. The left and right rear wheels 18B are preferably disposed between the screw assembly 403 and the electric motor 404 as seen in the left-right direction.

Since the left and right front wheels 18A are disposed in a position overlapping the screw assembly 403 as seen in the left-right direction, increase in the front-rear length of the slider 12 can be suppressed.

Since the left and right rear wheels 18B are disposed between the screw assembly 403 and the electric motor 404 as seen in the left-right direction, increase in the front-rear length of the slider 12 can be suppressed. The left and right rear wheels 18B can be supported by using the space between the screw assembly 403 and the electric motor 404.

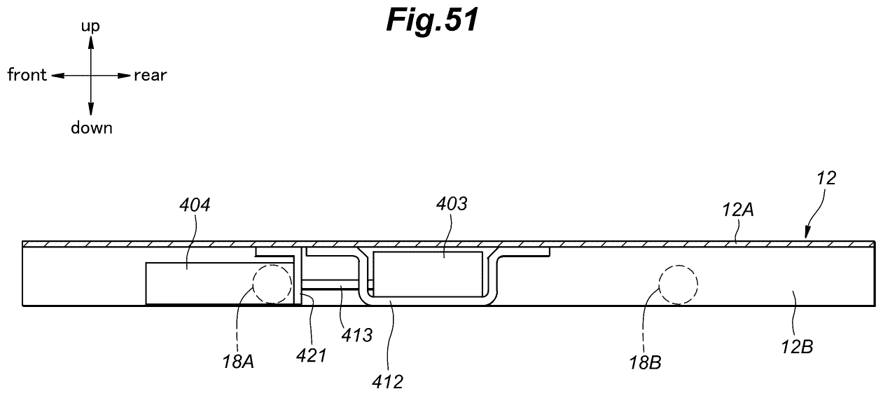

As shown in FIG. 51, in another embodiment, the screw assembly 403 and the electric motor 404 may be arranged in reverse order with respect to the front-rear direction. Namely, the electric motor 404 may be disposed in front of the screw assembly 403. In this case, the left and right front wheels 18A may be disposed in a position overlapping the electric motor 404 as seen in the left-right direction. The left and right rear wheels 18B are preferably disposed rearward of the screw assembly 403.

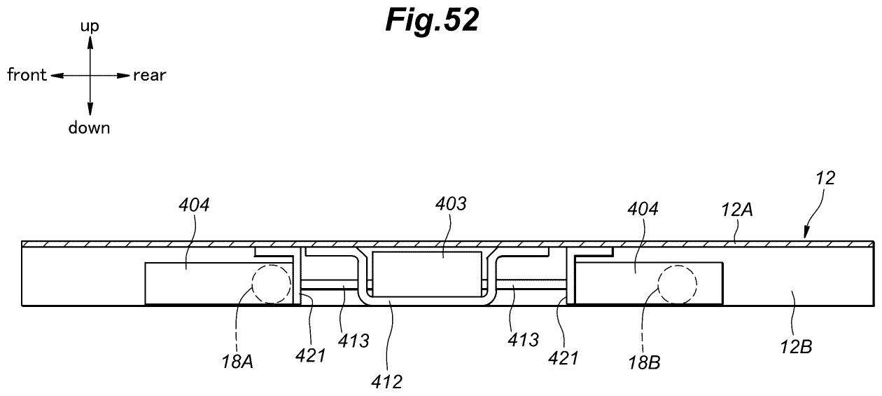

As shown in FIG. 52, in another embodiment, front and rear electric motors 404 may be disposed in front of and behind the screw assembly 403. In this case, preferably, the drive shaft 413 extends forward and rearward from the screw assembly 403 and is connected to the front and rear electric motors 404. The left and right front wheels 18A may be disposed in a position overlapping the front electric motor 404 as seen in the left-right direction. The left and right rear wheels 18B are preferably disposed rearward of the screw assembly 403. The front-rear length of each of the front and rear electric motors 404 is preferably longer than the front-rear length of the screw assembly 403. Thereby, it is possible to increase the torque of the front and rear electric motors 404.

As shown in FIG. 3, a gap is formed between the rail inner side wall 11D of the rail 11 and the slider inner side wall 12B of the slider 12 as seen from above. Through this gap, the worker can view the first screw member 406 and the second screw member 407 from above. An upper portion of the projection 11G of the rail inner side wall 11D and an upper portion of the recessed part 12E of the slider inner side wall 12B form parallel inclined surfaces that oppose each other. Thereby, intrusion of foreign matters to the gap between the slider inner side wall 12B of the slider 12 and the rail inner side wall 11D of the rail 11 is suppressed.

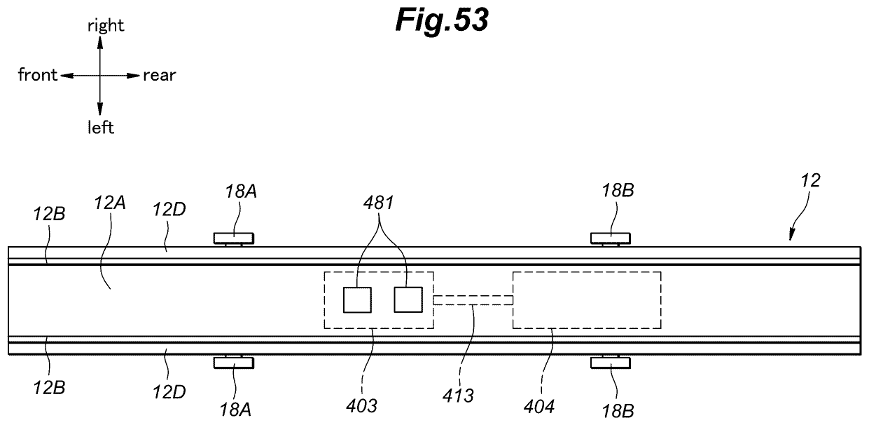

As shown in FIG. 53, in another embodiment, at least one check window 481 penetrating the slider upper wall 12A in the up-down direction may be formed. The check window 481 is preferably disposed above at least one of the screw assembly 403, the electric motor 404, and the drive shaft 413. The worker can view the screw assembly 403, etc. through the check window 481.

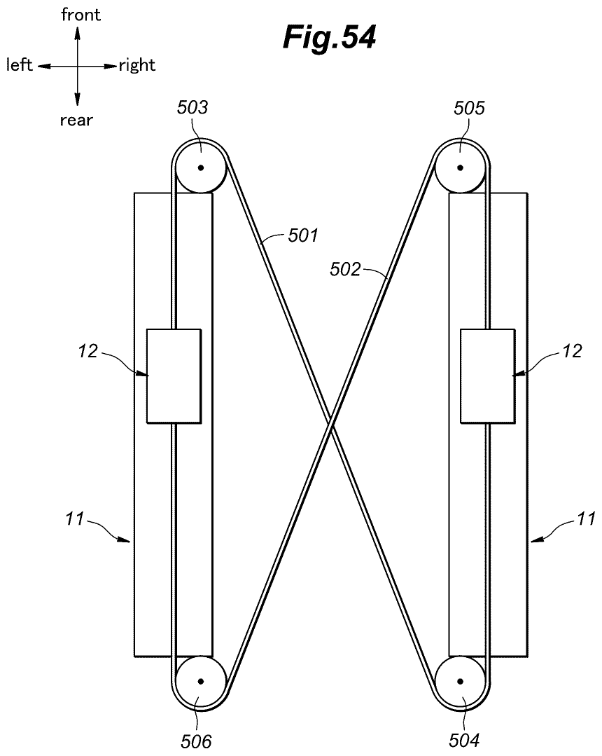

As shown in FIG. 54, the left and right sliders 12 may be connected to each other by a first wire 501 and a second wire 502. The first wire 501 connects the front end of the left slider 12 and the rear end of the right slider 12. The second wire 502 connects the front end of the right slider 12 and the rear end of the left slider 12.

The first wire 501 is wound around a first pulley 503 and a second pulley 504. The first pulley 503 is provided at the front end of the left rail 11, and the second pulley 504 is provided at the rear end of the right rail 11. The second wire 502 is wound around a third pulley 505 and a fourth pulley 506. The third pulley 505 is provided at the front end of the right rail 11, and the fourth pulley 506 is provided at the rear end of the left rail 11.

The first wire 501 and the second wire 502 extend to pass through the inside of the rails 11. The first wire 501, the second wire 502, and the first to fourth pulleys 503 to 506 are preferably disposed below the floor 2. Due to the first wire 501 and the second wire 502, the left and right sliders 12 move in synchronization with each other. The first wire 501 and the second wire 502 may be other linear members such as belts.

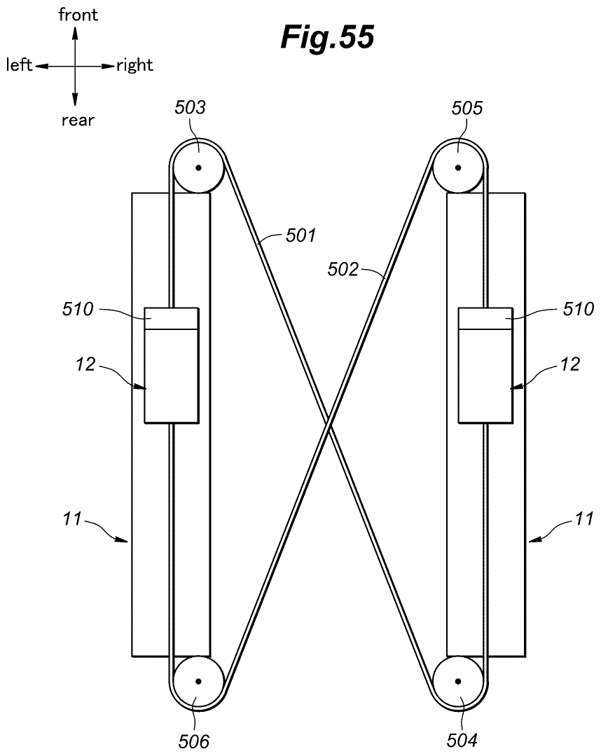

As shown in FIG. 55, sensors 510 for detecting tensile forces may be provided between the left slider 12 and the first wire 501 and between the right slider 12 and the second wire 502. The left and right electric motors 404 are preferably controlled based on the tensile forces detected by the sensors 510. For example, the left and right electric motors 404 are preferably controlled to reduce the tensile forces detected by the sensors 510.

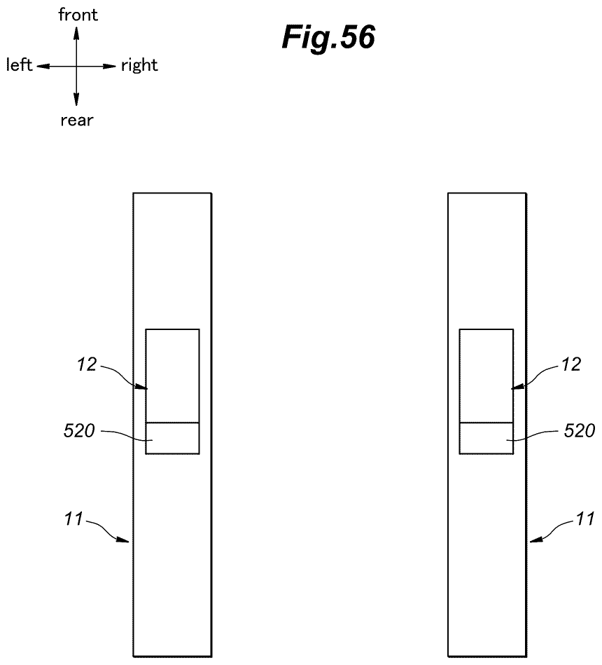

As shown in FIG. 56, sensors 520 for measuring the rotation speeds of the left and right electric motors 404 may be provided. The left and right electric motors 404 are preferably controlled such that their rotation speeds become the same. Each sensor 520 may be a variable resistor, a rotary encoder, or a Hall element, for example. Also, the left and right rails 11 may be provided with slider position sensors for detecting the positions of the corresponding sliders 12.

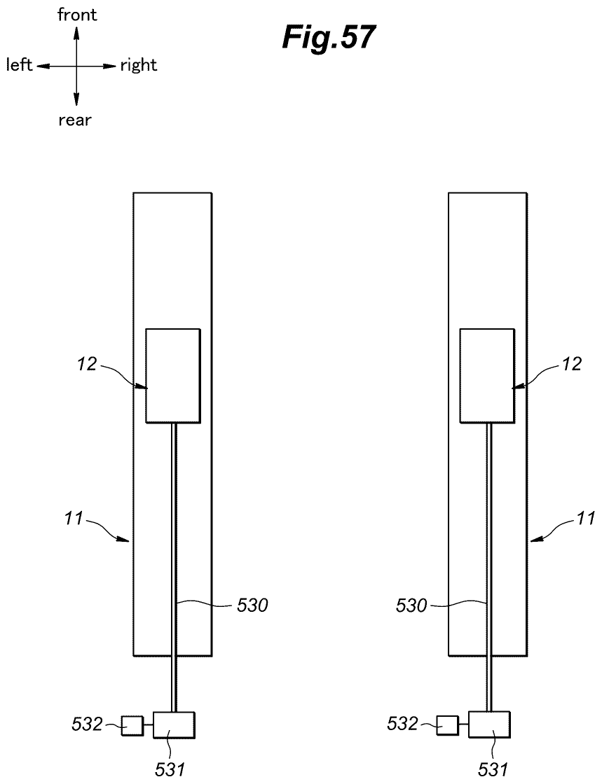

As shown in FIG. 57, wires 530 are connected to the rear ends of the left and right sliders 12. The wires 530 extend rearward through the inside of the respective rails 11. Behind the rails 11, reels 531 around which the respective wires 530 are wound are provided. The reels 531 are urged in a direction to take up the wires 530. Each reel 531 is provided with a variable resistor 532 for measuring the rotation speed. In this embodiment, the positions of the left and right sliders 12 are detected based on the rotation speeds of the left and right reels 531.

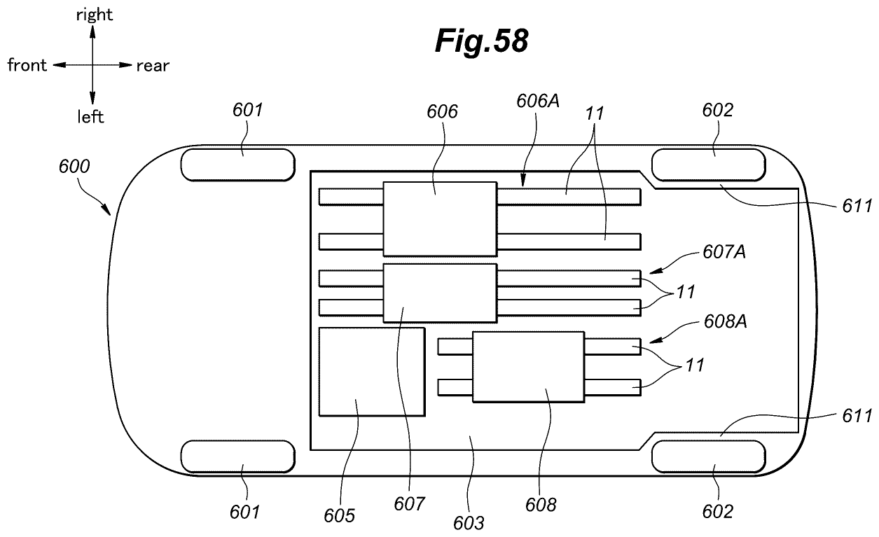

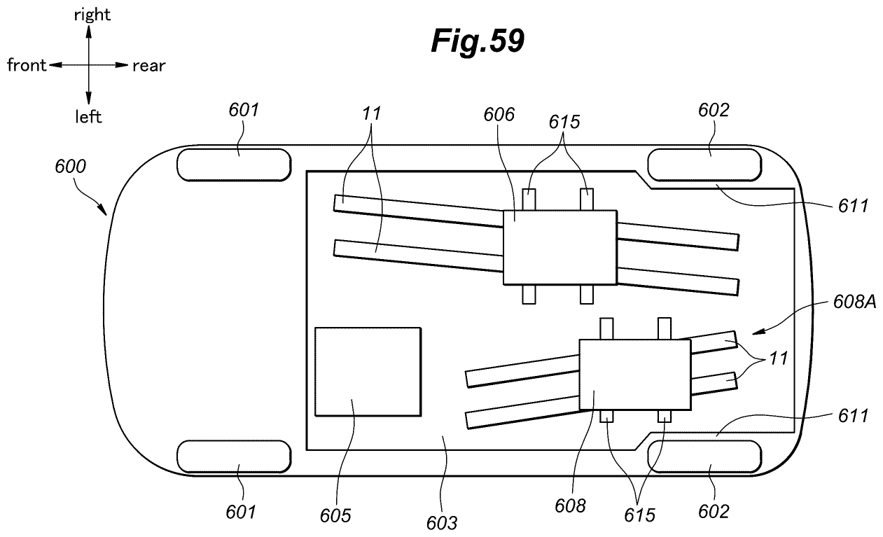

The electric slide rails 401, 450, 470 according to the above-described embodiments are provided in a vehicle 600 as shown in FIGS. 58 and 59. As shown in FIG. 58, the vehicle 600 includes left and right front wheels 601, left and right rear wheels 602, and a cabin 603. In the cabin 603, a driver's seat 605, a first seat 606, a second seat 607, and a third seat 608 are provided. The first seat 606 may be called a front passenger seat, the second seat 607 may be called a center seat, and the third seat 608 may be called a rear seat.

The driver's seat 605 is preferably provided in a left or right front part of the cabin 603. The first seat 606 is preferably provided in a part of the cabin 603 opposite from the driver's seat 605 in the left-right direction. The second seat 607 is preferably provided between the driver's seat 605 and the first seat 606. The third seat 608 is preferably disposed behind the driver's seat 605.

An electric slide rail 606A for the first seat 606, an electric slide rail 607A for the second seat 607, and an electric slide rail 608A for the third seat 608 may be any of the electric slide rails 401, 450, 470 described above.

The left and right rails 11 of the electric slide rail 606A for the first seat 606 preferably extend in the front-rear direction from the front part of the cabin 603 to the rear wheels 602. The rear ends of the left and right rails 11 of the electric slide rail 606A may be disposed rearward of the front ends of the rear wheels 602.

The left and right rails 11 of the electric slide rail 607A for the second seat 607 preferably extend in the front-rear direction from the front part of the cabin 603 to the rear wheels 602. The rear ends of the left and right rails 11 of the electric slide rail 607A may be disposed rearward of the front ends of the rear wheels 602.

The left and right rails 11 of the electric slide rail 607A for the third seat 608 preferably extend in the front-rear direction from the rear portion of the driver's seat 605 to the rear wheels 602. The rear ends of the left and right rails 11 of the electric slide rail 607A may be disposed rearward of the front ends of the rear wheels 602.

The rear ends of the left and right rails 11 of each of the electric slide rail 606A, 607A, 608A may be disposed at the rear end of the cabin 603.

As shown in FIG. 59, the second seat 607 may be omitted. The left and right rails 11 of the electric slide rail 606A for the first seat 606 may be provided to be inclined relative to the front-rear direction. For example, the left and right rails 11 of the electric slide rail 606A for the first seat 606 may be inclined laterally inward toward the rear. The left and right rails 11 of the electric slide rail 606A for the first seat 606 are preferably disposed to avoid wheel houses 611 of the rear wheels 602. The front end of one of the left and right rails 11 of the electric slide rail 606A for the first seat 606 is preferably disposed forward of the wheel houses 611 of the rear wheels 602. The same applies to the left and right rails 11 of the electric slide rail 608A for the third seat 608.

Each electric slide rail 606A, 608A may be joined to the seat cushion of the corresponding seat 606, 608 via a lateral slide device 615. The lateral slide device 615 includes lower rails extending in the left-right direction and upper rails joined to the lower rail to be slidingly movable in the left-right direction. The lower rails are joined to the left and right sliders 12 of each electric slide rail 606A, 608A. The upper rails are joined to the seat cushion of each seat 606, 608. Due to the lateral slide device 615, each seat 606, 608 can move in the lateral direction. Therefore, interference with the wheel houses 611 of the rear wheels 602 can be further avoided.

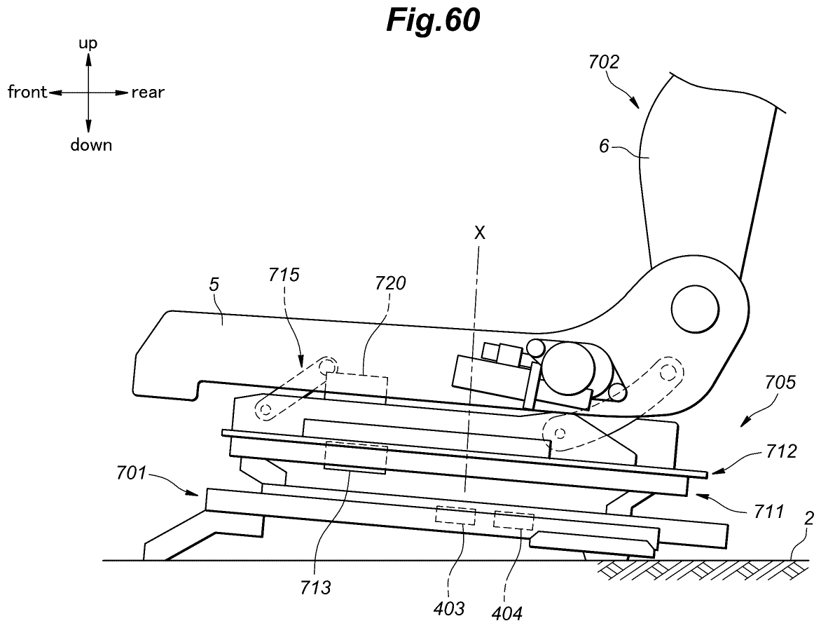

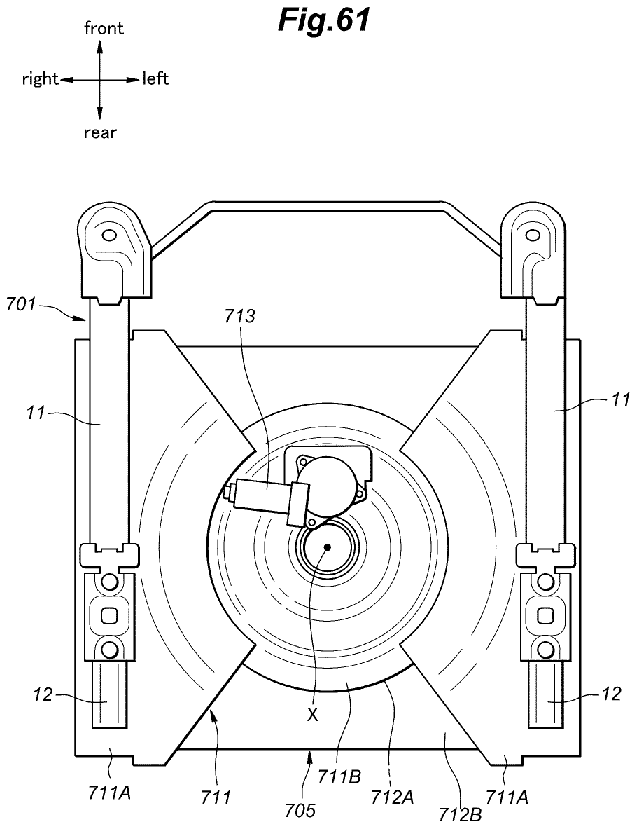

As shown in FIGS. 60 and 61, a vehicle seat 702 provided with an electric slide rail 701 may be rotatable about an axis X extending in the up-down direction. The electric slide rail 701 may be any of the electric slide rails 401, 450, 470 of the above-described embodiments. The configurations of the electric slide rail 701 are denoted by the same reference signs as those of the electric slide rails 401, 450, 470, and the description thereof will be omitted.

The vehicle seat 702 includes a rotation device 705 provided between the seat cushion 5 and the left and right sliders 12 and supporting the seat cushion 5 to be rotatable relative to the left and right sliders 12. The rotation device 705 includes a base part 711 joined to the left and right sliders 12, a rotating part 712 provided on the seat cushion 5 and supported by the base part 711 to be rotatable about the axis X, and an electric motor 713 for rotating the rotating part 712 relative to the base part 711. Between the rotating part 712 and the seat cushion 5, a lift device 715 may be provided. The lift device 715 raises and lowers the seat cushion 5 relative to the rotating part 712.

The base part 711 includes left and right lower side plates 711A joined to the left and right sliders 12 and a lower center plate 711B having a disc shape and joined to the left and right lower side plates 711A. The rotating part 712 includes an upper center plate 712A having a disc shape and supported by the lower center plate 711B to be rotatable about the axis X and an upper plate 712B joined to the upper center plate 712A. The seat cushion 5 is preferably joined to the upper plate 712B.

On the lower surface of the seat cushion 5, a control device 720 for controlling electrical equipment provided on the seat cushion 5 and the seatback 6 is provided. The control device 720 is an electronic control unit and is a calculation device including a microprocessor (MPU), a non-volatile memory, a volatile memory, and an interface. The control device 720 realizes various applications by executing programs stored in the non-volatile memory with the microprocessor. The electrical equipment preferably includes a seat heater, a blower, the electric slide rail 701, and the lift device 715.

The axis X of the rotation device 705 is disposed in a position overlapping the left and right screw assemblies 403 of the electric slide rail 701 as seen in the left-right direction. The left and right screw assemblies 403 of the electric slide rail 701 are disposed rearward of the electric motor 713 as seen in the left-right direction.

The left and right electric motors 404 of the electric slide rail 701 are disposed rearward of the electric motor 713 as seen in the left-right direction. The left and right electric motors 404 of the electric slide rail 701 are disposed rearward of the control device 720 as seen in the left-right direction.

As shown in FIG. 61, as seen in the upward direction, the left and right screw assemblies 403 of the electric slide rail 701 are disposed radially outward of the lower center plate 711B and the upper center plate 712A, with the axis X being the center. Namely, as seen in the upward direction, the left and right screw assemblies 403 of the electric slide rail 701 are disposed laterally outward of the lower center plate 711B and the upper center plate 712A.

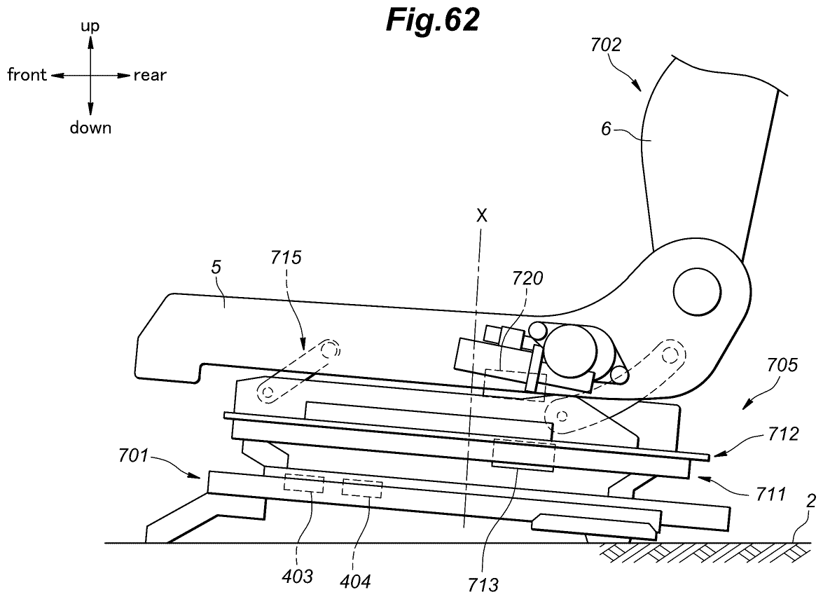

In another embodiment, as shown in FIG. 62, the left and right screw assemblies 403 and the left and right electric motors 404 of the electric slide rail 701 may be disposed forward of the axis X of the rotation device 705 as seen in the left-right direction.

The left and right electric motors 404 of the electric slide rail 701 may be disposed forward of the electric motor 713 as seen in the left-right direction. The left and right electric motors 404 of the electric slide rail 701 may be disposed forward of the control device 720 as seen in the left-right direction.

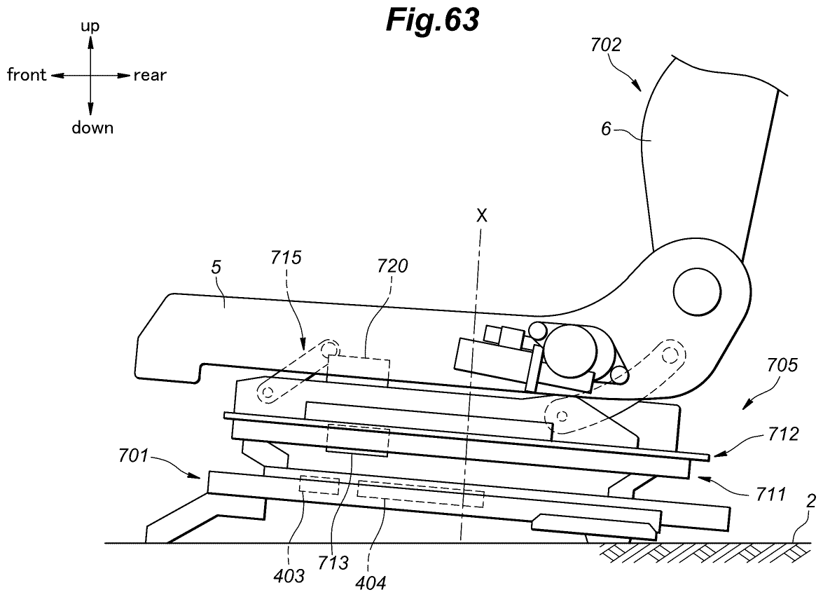

In another embodiment, as shown in FIG. 63, the axis X of the rotation device 705 is disposed in a position overlapping the left and right electric motors 404 of the electric slide rail 701 as seen in the left-right direction. The rear ends of the left and right electric motors 404 of the electric slide rail 701 may be disposed rearward of the axis X of the rotation device 705 as seen in the left-right direction. The left and right screw assemblies 403 of the electric slide rail 701 may be disposed forward of the electric motor 713 as seen in the left-right direction. The rear ends of the left and right electric motors 404 of the electric slide rail 701 may be disposed forward of the electric motor 713 as seen in the left-right direction.

The rear ends of the left and right electric motors 404 of the electric slide rail 701 may be disposed rearward of the control device 720 as seen in the left-right direction.

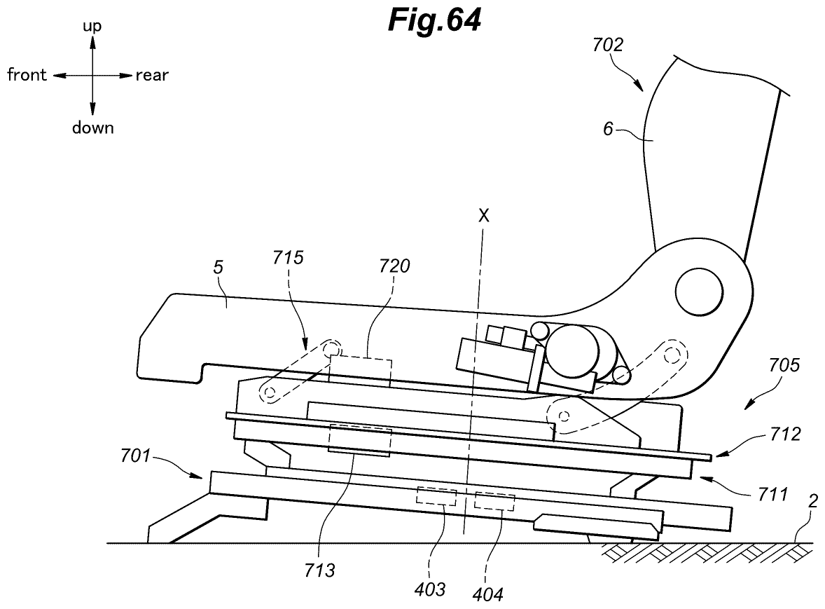

In another embodiment, as shown in FIG. 64, the axis X of the rotation device 705 passes between the rear ends of the left and right screw assemblies 403 of the electric slide rail 701 and the front ends of the left and right electric motors 404 as seen in the left-right direction. The left and right screw assemblies 403 of the electric slide rail 701 are preferably disposed rearward of the electric motor 713 as seen in the left-right direction. The left and right electric motors 404 of the electric slide rail 701 may be disposed rearward of the electric motor 713 as seen in the left-right direction. The rear ends of the left and right electric motors 404 of the electric slide rail 701 may be disposed rearward of the control device 720 as seen in the left-right direction.

Concrete embodiments have been described in the foregoing, but the present invention can be modified in various ways without being limited to the above embodiments.

### LIST OF REFERENCE NUMERALS

1: slide device
2: floor
3: vehicle seat
11: rail
11A: rail bottom wall
11B: rail outer side wall
11C: rail upper wall
11D: rail inner side wall
12: slider
12A: slider upper wall
12B: slider inner side wall
12F: slider opening
15: locking hole
30: slide lock device
31: casing
31A: lower casing member
31B: upper casing member
31C: helical groove
31D: casing opening
32: lock member
32A: shaft part
32B: convex part
32C: arm part
33 urging member
34: operating member
34A: main body
34B: pressing part
34C: support shaft
35: insertion hole
36 operation hole
37: urging member

1. A slide lock device for a slide device, wherein
the slide device comprises a rail and a slider slidably supported on the rail, the rail being provided with multiple locking holes arranged in an extension direction of the rail,
the slide lock device comprises a casing joined to the slider, at least one lock member supported by the casing to be rotatable between a release position and a lock position, an urging member urging the lock member toward the lock position, and an operating member displaceably supported by the casing and contacting the lock member,
the lock member comprises at least one convex part configured to be engaged with the locking holes when the lock member is in the lock position and to be disengaged from the locking holes when the lock member is in the release position, and
when the operating member is moved from an initial position to a post-operation position, the operating member presses the lock member and moves the lock member from the lock position to the release position.

2. The slide lock device according to claim 1, wherein the operating member is supported by the casing to be pivotable between the initial position and the post-operation position.

3. The slide lock device according to claim 1, wherein the convex part extends helically about a rotation axis of the lock member, and
the casing is provided with a helical groove for slidably receiving the convex part.

4. The slide lock device according to claim 1, wherein the convex part protrudes from the casing when the lock member is in the lock position, and the convex part is positioned within the casing when the lock member is in the release position.

5. The slide lock device according to claim 1, wherein the lock member includes an arm part protruding in a direction perpendicular to the rotation axis of the lock member,
the operating member presses the arm part in a first direction parallel to a tangential direction about the rotation axis of the lock member, and
the arm part and the operating member have no overlap in the first direction when the lock member reaches the release position.

6. The slide lock device according to claim 5, wherein a pair of the lock members are disposed in parallel with each other,
a pair of the arm parts extend in directions toward each other when each of the lock members is in the lock position, and
the operating member contacts each of the pair of the arm parts.

7. The slide lock device according to claim 1, wherein the slider includes an upper wall and a pair of side walls extending downward from the upper wall,
the casing is joined to a bottom surface of the upper wall and is disposed between the pair of side walls, and
parts of the pair of side walls opposing the casing are formed with an opening through which the convex part can pass.

8. The slide lock device according to claim 7, wherein the operating member protrudes above the upper wall by passing through an operation hole formed in the upper wall.

9. An assembly method for a slide device, wherein
the slide device comprises a rail, a slider slidably supported on the rail, and a slide lock device provided on the slider and configured to be engaged with the rail, the rail being provided with multiple locking holes arranged in an extension direction of the rail,
the slide lock device comprises a casing joined to the slider, at least one lock member supported by the casing to be rotatable between a release position and a lock position, an urging member urging the lock member toward the lock position, and an operating member displaceably supported by the casing and contacting the lock member, and
the lock member comprises at least one convex part configured to be engaged with the locking holes when the lock member is in the lock position and to be disengaged from the locking holes when the lock member is in the release position,
the assembly method comprising:
a step of assembling the slide lock device by mounting the lock member, the urging member, and the operating member to the casing;
a step of mounting the casing to the slider; and
a step of mounting the slider to the rail.

10. The assembly method for a slide device according to claim 9, wherein the casing includes multiple casing members, and
the step of assembling the slide lock device comprises:
a step of mounting the urging member to the lock member;
a step of making one of the multiple casing members support the lock member to which the urging member is mounted and the operating member; and
a step of joining the multiple casing members to each other.
